(19) United States
(12) Patent Application Publication
(10) Pub. No.: US 2026/0352750 A1
(43) Pub. Date: Nov. 5, 2026

(54) PROTECTIVE CASE AND METHOD FOR MAKING PROTECTIVE CASE

(71) Applicant: SHENZHEN LINGYI INNOVATION TECHNOLOGY CO., LTD., Shenzhen (CN)

(72) Inventors: Yanhui Li, Shenzhen (CN); Shaohua Chen, Shenzhen (CN); Yanghui Zheng, Shenzhen (CN)

(21) Appl. No.: 19/237,597

(22) Filed: Jun. 13, 2025

Related U.S. Application Data
(63) Continuation of application No. PCT/CN2025/092592, filed on Apr. 30, 2025.

(51) Int. Cl. H04M 1/02

(52) U.S. Cl. CPC H04M 1/0203

(57) ABSTRACT

A protective case includes a case body, a flexible connection part, and a first button part. The case body defines an opening. The first button part is integrated with the case body through the flexible connection part, and is located at the opening. Along a thickness direction of the case body, a projection of the first button part is located in the opening. Stiffness of the case body is greater than stiffness of the flexible connection part.

### CROSS-REFERENCE TO RELATED APPLICATIONS

The present application is a continuation of International Patent Application No. PCT/CN2025/092592, filed on Apr. 30, 2025, which is herein incorporated by reference in its entirety.

### TECHNICAL FIELD

The present disclosure relates to the field of electronic device accessory technologies, and in particular to a protective case and a method for making the protective case.

### BACKGROUND

Electronic devices such as mobile phones, laptops, and the like are usually assembled inside protective cases for protection. In order to achieve protection for the electronic device, the protective case typically has a certain degree of rigidity and is generally hard, with poor plasticity or elasticity, making it inconvenient to operate a button of the electronic device through the protective case. In related art, the protective case often defines an opening at a position corresponding to the button of the electronic device, so as to expose the button for user operation. However, this structure leaves the button of the electronic device unprotected. Alternatively, a discrete button cover may be disposed at the opening. The button cover may be attached to the button to provide protection. However, the button cover is prone to falling off, resulting in poor protection for the electronic device.

### SUMMARY OF THE DISCLOSURE

The present disclosure provides a protective case. The protective case includes a case body defining an opening, a flexible connection part, and a first button part. The first button part is integrated with the case body through the flexible connection part and is located at the opening. Along a thickness direction of the case body, a projection of the first button part is located in the opening.

The present disclosure further provides a protective case. The protective case includes a case body defining an opening, a flexible connection part, and a first button part. The case body includes an aramid fiber layer made of an aramid fiber material. The first button part is integrated with the case body through the flexible connection part and is located at the opening.

### BRIEF DESCRIPTION OF THE DRAWINGS

In order to more clearly describe the technical solutions in some embodiments of the present disclosure, hereinafter, the accompanying drawings that are used in the description of some embodiments will be briefly described. Obviously, the accompanying drawings in the description below merely show some embodiments of the present disclosure. For those of ordinary skill in the art, other accompanying drawings may be obtained based on these accompanying drawings without any creative efforts.

FIG. 1 is a structural schematic view of an embodiment of a protective case in the present disclosure.

FIG. 2 is a structural schematic view of an embodiment of a case body in the present disclosure.

FIG. 3 is a structural schematic view of an embodiment of an electronic device in the present disclosure.

FIG. 4 is an enlarged structural schematic view of an A area of FIG. 1.

FIG. 5 is a layered structural schematic view of an embodiment of partial structure of the protective case in the present disclosure.

FIG. 6 is a layered structural schematic view of another embodiment of partial structure of the protective case in the present disclosure.

FIG. 7 is a layered structural schematic view of yet another embodiment of partial structure of the protective case in the present disclosure.

FIG. 8 is a layered structural schematic view of yet another embodiment of partial structure of the protective case in the present disclosure.

FIG. 9 is a layered structural schematic view of yet another embodiment of partial structure of the protective case in the present disclosure.

FIG. 10 is a layered structural schematic view of yet another embodiment of partial structure of the protective case in the present disclosure.

FIG. 11 is an enlarged structural schematic view of a B area of FIG. 5.

FIG. 12 is a structural schematic view of another embodiment of the case body in the present disclosure.

FIG. 13 is a structural schematic view of an embodiment of a first button part in the present disclosure.

FIG. 14 is a structural schematic view of an embodiment of a button body in the present disclosure.

FIG. 15 is a structural schematic view of yet another embodiment of partial structure of the protective case in the present disclosure.

FIG. 16 is a structural schematic view of an embodiment of a first body layer in the present disclosure.

FIG. 17 is a structural schematic view of yet another embodiment of partial structure of the protective case in the present disclosure.

FIG. 18 is a structural schematic view of yet another embodiment of partial structure of the protective case in the present disclosure.

FIG. 19 is a structural schematic view of an embodiment of a conductive layer in the present disclosure.

FIG. 20 is a structural schematic view of yet another embodiment of partial structure of the protective case in the present disclosure.

FIG. 21 is a structural schematic view of yet another embodiment of partial structure of the protective case in the present disclosure.

FIG. 22 is a structural schematic view of yet another embodiment of partial structure of the protective case in the present disclosure.

FIG. 23 is a structural schematic view of yet another embodiment of partial structure of the protective case in the present disclosure.

FIG. 24 is a structural schematic view of yet another embodiment of partial structure of the protective case in the present disclosure.

FIG. 25 is a structural schematic view of yet another embodiment of partial structure of the protective case in the present disclosure.

FIG. 26 is a structural schematic view of an embodiment of a second button part in the present disclosure.

FIG. 27 is an exploded structural schematic view of an embodiment of partial structure of the protective case in the present disclosure.

FIG. 28 is a structural schematic view illustrating partial structures of the protective case and the electronic device in an embodiment of the present disclosure.

FIG. 29 is a cross-sectional structural schematic view illustrating partial structure of the protective case after a molding process in an embodiment of the present disclosure.

FIG. 30 is a structural schematic view illustrating the protective case and partial structure of the electronic device in another embodiment of the present disclosure.

FIG. 31 is a flowchart of an embodiment of a method for making the protective case in the present disclosure.

FIG. 32 is a flowchart of an embodiment of an operation at block S13 in FIG. 31.

FIG. 33 is a structural schematic view of yet another embodiment of partial structure of the protective case in the present disclosure.

FIG. 34 is a structural schematic view of yet another embodiment of partial structure of the protective case in the present disclosure.

FIG. 35 is a cross-sectional structural schematic view illustrating partial structure of the protective case after the molding process in another embodiment of the present disclosure.

FIG. 36 is a cross-sectional structural schematic view illustrating partial structure of the protective case after the molding process in yet another embodiment of the present disclosure.

FIG. 37 is a structural schematic view of yet another embodiment of partial structure of the protective case in the present disclosure.

### DETAILED DESCRIPTION

The present disclosure may be explained in detail by combining the accompanying drawings and embodiments. It should be noted that the following embodiments are only used to illustrate the present disclosure, but do not limit the scope of the present disclosure. Similarly, the following embodiments are only a part of the embodiments of the present disclosure, and not all embodiments. All other embodiments obtained by those of ordinary skill in the art without creative effort are within the scope of the present disclosure.

In the description of the embodiments of the present disclosure, it should be noted that unless otherwise expressly specified and limited, the terms “connection” and “connected” should be broadly understood. For example, it may be a fixed connection, a detachable connection, or an integrated connection; it may be a mechanical connection or an electrical connection; it may be a direct connection or an indirect connection through an intermediate medium. For those of ordinary skill in the art, the specific meanings of the above terms may be understood according to specific situations.

In the embodiments of the present disclosure, unless otherwise expressly specified and limited, a first feature is above or below a second feature, which means that the first feature is in direct contact with the second feature, or the first feature is in indirect contact with the second feature through an intermediate medium. Moreover, the first feature is above the second feature, which may indicate that the first feature may be directly above or diagonally above the second feature, or simply indicate that a horizontal height of the first feature is greater than that of the second feature. The first feature is below the second feature, which may indicate that the first feature may be directly below or diagonally below the second feature, or simply indicate that the horizontal height of the first feature is less than that of the second feature.

In the description of the present disclosure, reference terms, such as “an embodiment”, “some embodiments”, “examples”, “specific examples”, “some examples” or the like, mean that specific features, structures, materials, or features described in conjunction with the embodiments or examples may be included in at least one embodiment or example of the present disclosure. In the present specification, illustrative expressions of the above reference terms do not necessarily refer to the same embodiments or examples. Moreover, the specific features, the structures, the materials, or the characteristics described may be combined in an appropriate manner in any one or more embodiments or examples. In addition, without mutual contradiction, those of skilled in the art may combine different embodiments or examples, and combine the features of the different embodiments or examples described in the present specification.

The present disclosure provides a protective case and a method for making the protective case, so as to improve the structural stability of the protective case and further improve the protective capability for an electronic device.

The protective case provided by the present disclosure is applicable to a variety of electronic devices. These electronic devices may be devices that are able to operate independently of the cases and/or in conjunction with the cases. For example, the protective case may be used for the electronic devices, such as mobile phones, tablet computers, portable media players, cameras, or other portable electronic devices, providing enhanced protection for the electronic device. The embodiments of the present disclosure may be described using a mobile phone as an example, and the protective case may also be described using the protective case of the mobile phone as an example.

### Example Group 1

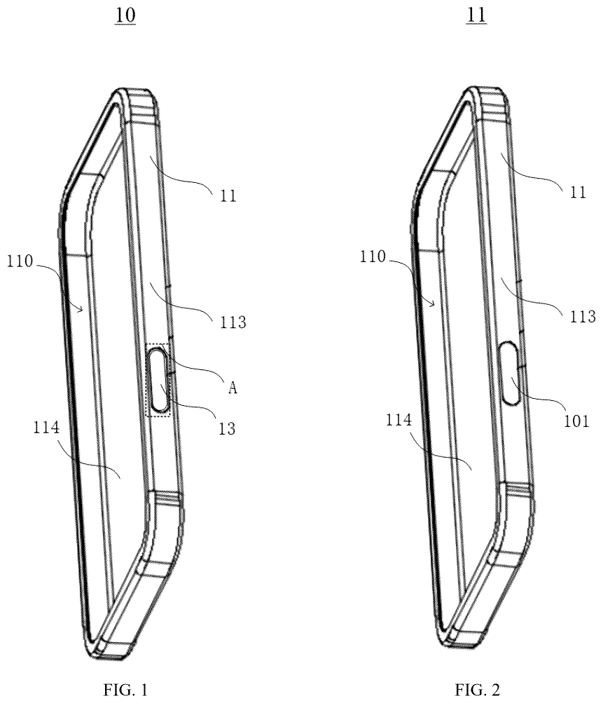

In some embodiments, as shown in FIGS. 1 to 36, the protective case 10 includes a case body 11, a flexible connection part 12, and a first button part 13. The case body 11 defines an opening 101. The first button part 13 is integrated with the case body 11 through the flexible connection part 12, and the first button part 13 is located at the opening 101. Along a thickness direction z of the case body 11, a projection of the first button part 13 is located in the opening 101.

The case body 11 defines an accommodation chamber 110 that is configured for accommodating at least a part of an electronic device 20, and the opening 101 is communicated with the accommodation chamber 110. The first button part 13 is configured to abut against or be adjacent to a function button 21 of the electronic device 20 installed inside the case body 11, so as to trigger the function button 21 of the electronic device 20 when a user touches the first button part 13.

The first button part 13 is an area where the user performs a button operation. In some embodiments, the protective case 10 is configured to protect the electronic device 20, the electronic device 20 is provided with the function button 21. When the electronic device 20 is assembled inside the protective case 10, the first button part 13 covers at least a part of the function buttons 21. Therefore, the user may trigger corresponding function button 21 by pressing the first button part 13, ensuring the normal response of the function button 21 during use.

In some embodiments, the first button part 13 may directly abut against the function button 21. Alternatively, there is a very small gap between the first button part 13 and the function button 21, so that when the user's finger is placed or slid on the first button part 13, the touch response of the function button 21 of the electronic device 20 may be triggered. When the user's finger is not placed on the first button part 13, the first button part 13 may not apply an excessive bias force to the function button 21, avoiding erroneous triggering of the function button 21 due to the above reasons.

In the present disclosure, the thickness direction z of the case body 11 refers to a thickness direction of a wall part defining the opening 101, and the thickness direction may be parallel to a pressing direction when the user performs the button operation. In some embodiments, the case body 11 includes a side wall 113 and a bottom wall 114. The side wall 113 is located around the outer periphery of the bottom wall 114, and the side wall 113 and the bottom wall 114 enclose to form the accommodation chamber 110. The accommodation chamber 110 is configured to accommodate at least a part of the electronic device 20. When the opening 101 is defined on the side wall 113, the thickness direction z refers to the thickness direction of the side wall 113 of the case body 11. In this case, the thickness direction z is perpendicular to the side wall 113, and the pressing direction in which the user presses the first button part 13 is perpendicular to the side wall 113. When the opening 101 is defined on the bottom wall 114, the thickness direction z mentioned above refers to a thickness direction of the bottom wall 114. In this case, the thickness direction z is perpendicular to the bottom wall 114, and the pressing direction in which the user presses the first button part 13 is perpendicular to the bottom wall 114.

In some embodiments, the case body 11 may include a top wall. The top wall, the bottom wall 114, and the side walls 113 enclose to form a fully enclosed accommodation chamber 110, so as to completely enclose the electronic device 20.

The position of the opening 101 corresponds to the function button 21 of the electronic device 20. For example, when the function button 21 of the electronic device 20 is disposed on a side surface, the opening 101 is correspondingly defined on the side wall 113 of the case body 11. When the function button 21 of the electronic device 20 is disposed on a back face, the opening 101 is correspondingly defined on the bottom wall 114 of the case body 11.

The accommodating chamber 110 is configured to accommodate and couple the electronic devices 20. One or more coupling structures configured for holding and coupling the electronic device 20 in the accommodation chamber 110 may also be disposed in the accommodation chamber 110. The coupling structure includes, but is not limited to, a flexure component, a guide rail, a channel, a fastener, a magnet, and a friction coupling component. The coupling between the protective case 10 and the electronic device 20 is continuous, ensuring that the protective case 10 and the electronic device 20 may not accidentally separate during use. The protective case 10 and the electronic device 20 may be coupled in a removable manner, allowing the electronic device 20 to be removed according to the user's needs. In this way, the coupling between the protective case 10 and the electronic device 20 is reversible, allowing each of the protective case 10 and the electronic device 20 to return to its original state before coupling.

In some embodiments, the protective case 10 may be a monolithic structure or may be formed from multiple discrete parts (made of the same or different materials). For example, the back face of a back panel of the protective case 10 may be made of a rigid material, while other parts of the protective case 10 (such as a frame) may be made of an elastic material. Alternatively, the protective case 10 may include an upper case and a lower case, or the protective case 10 may include a left case and a right case. In some embodiments, an additional layer may also be disposed in the accommodation chamber 110. The additional layer may be a material for contacting the electronic device 20, including but not limited to microfiber, fabric, foam, rubber, etc. The additional layer may also be made of a material for case heat dissipation and/or to avoid damage to the electronic device 20.

After a molding process of the protective case 10 is completed, in the thickness direction z of the case body 11, components near the opening 101, such as the first button part 13 and the flexible connection part 12, etc., may undergo displacement due to hot-pressing or other molding processes. Therefore, in the present disclosure, the accompanying drawings are only schematic view illustrating the arrangement of the layered structure of the components of the protective case 10.

The flexible connection part 12 may connect the first button part 13 and the case body 11, so that the first button part 13 is integrated with the case body 11, and a force-bearing part of the flexible connection part 12 may undergo displacement relative to the case body 11. Therefore, when the first button part 13 is subjected to a force, the first button part 13 may undergo relative displacement relative to the case body 11 through the flexible connection part 12. The projection of the first button part 13 along the thickness direction z of the case body 11 is located in the opening 101. Therefore, the user may press the first button part 13, so that the first button part 13 undergoes displacement along the thickness direction z of the case body 11, thereby achieving operation of the electronic device 20 inside the protective case 10.

The projection of the first button part 13 along the thickness direction z of the case body 11 is located in the opening 101, which means that the first button part 13 is located in the opening 101, or the first button part 13 is located on an inner side or an outer side of the opening 101 along the thickness direction z of the case body 11, and directly faces or aligns with the opening 101.

There are various ways to achieve the integrated setting. For example, by applying heating or pressure, relevant materials in at least two material layers may be melted, flow to a specific position under the action of pressure or a mold, and then solidify under the influence of temperature or pressure. Alternatively, the material layers may be adhered together using adhesive or the like and then cured to form a connection. The integrated setting mentioned here ensures that at least two material layers form an inseparable whole under non-violent intervention, which is also referred to as a “monolithic structure” or “one-piece structure”.

In some embodiments, the flexible connection part 12 is integrated with the case body 11 through hot-pressing. In this way, while ensuring the connection strength between the flexible connection part 12 and the case body 11, the manufacturing process may be simplified and production efficiency may be improved.

In some embodiments, the flexible connection part 12 and the case body 11 may be formed by two-shot injection molding. For example, when the flexible connection part 12 and the first button part 13 are made of different types of thermoplastic resins, the flexible connection part 12, the first button part 13, and the case body 11 may be manufactured using two-shot injection molding. In this way, it is possible to reduce labor and logistics costs, and avoid tolerance accumulation caused by separate assembly.

The flexible connection part 12 is prone to deformation under an external force, which may improve the flexibility of relative displacement between the first button part 13 and the case body 11, and improve sensitivity and reliability of an external operation on the electronic device 20. Furthermore, the case body 11 may form a rigid area of the protective case 10, which may effectively protect the entire electronic device 20. Furthermore, the case body 11 may be integrated with the first button part 13, which may improve structural stability of the protective case 10, save material costs, and facilitate miniaturization of a combination structure formed by the protective case 10 and the electronic device 20.

In this way, on the one hand, the first button part 13 located at the opening 101 of the case body 11 is connected to the case body 11 through the flexible connection part 12, which may improve movement ability of the first button part 13 relative to the case body 11, so that the protective case 10 has a local flexible area. This may improve tactile feel of the first button part 13 and reduce the influence of the case body 11 on the operation of the first button part 13, thereby improving precision of operating the electronic device 20. On the other hand, the first button part 13 is disposed at the opening 101 of the case body 11 and the first button part 13 is connected to the case body 11 through the flexible connection part 12, which may increase sealing of the opening 101 through the first button part 13 and the flexible connection part 12, thereby solving the problem of the corresponding button of the electronic device 20 being exposed and not effectively protected. For another thing, the case body 11, the flexible connection part 12, and the first button part 13 are integrated, which may improve the structural stability of the protective case 10. It addresses issues arising from separate assembly, such as insufficient connection strength and the tendency to come loose, thereby further improving the protective capability for the electronic device 20.

In some embodiments, stiffness of the case body 11 is greater than stiffness of the flexible connection part 12. Stiffness refers to magnitude of the force required to produce a unit of deformation when the external force is applied to a structure, and it can reflect the flexibility of the material. In the vast majority of cases, the greater the stiffness of the material, the smaller its ability to deform and the less flexible it is.

The stiffness of the case body 11 refers to the magnitude of the force required to produce a unit of deformation in the case body 11 when the external force is applied to the case body 11. The stiffness of the flexible connection part 12 refers to the magnitude of the force required to produce a unit of deformation in the flexible connection part 12 when the external force is applied to the flexible connection part 12. When an equal magnitude of force is applied to the case body 11 and the flexible connection part 12, the deformation generated by the case body 11 is smaller than the deformation generated by the flexible connection part 12.

The stiffness of the case body 11 is greater than the stiffness of the flexible connection part 12, which may facilitate the pressing and rebound operation of the first button part 13, making the feedback of the pressing and rebound of the first button part 13 clearer and the tactile feel more comfortable. Moreover, the flexible connection part 12 is prone to deformation under the external force, which may reduce the difficulty of disassembling and assembling the protective case 10. Furthermore, as the main body of the protective case 10, the case body 11 may effectively protect the entire electronic device 20.

A material of the case body 11 and a material of the flexible connection part 12 may be different to achieve different stiffness. For example, the case body 11 may be made of fiber material or high elastic modulus material, such as polycarbonate (PC). The flexible connection part 12 may be made of low elastic modulus material, such as thermoplastic polyurethane (TPU), rubber, silicone, etc. Alternatively, the material of the case body 11 may be the same as the material of the flexible connection part 12, such as both using TPU. However, different stiffness TPU may be used, or the thickness of the case body 11 may be greater than the thickness of the flexible connection part 12, so that the stiffness of the case body 11 is greater than the stiffness of the flexible connection part 12.

In some embodiments, the stiffness of each area of the flexible connection part 12 may remain consistent. In some embodiments, the stiffness of each area of the flexible connection part 12 may also be inconsistent, and there is no specific limitation.

In some embodiments, the stiffness of all areas of the flexible connection part 12 is consistent. Alternatively, the stiffness gradually increases from the first button part 13 to the case body 11, so as to increase the connection stability between the flexible connection part 12 and the case body 11 during deformation.

In some embodiments, the stiffness of all areas of the case body 11 is consistent. Alternatively, the stiffness gradually increases from the opening 101 to the area away from the opening 101, so as to increase the connection stability between the flexible connection part 12 and the case body 11 during deformation.

In some embodiments, the stiffness of the first button part 13 is less than the stiffness of the case body 11, so that the deformation ability of the first button part 13 is greater than the deformation ability of the case body 11, facilitating the user's pressing operation.

In some embodiments, the elasticity of the flexible connection part 12 is greater than the elasticity of the case body 11. In this way, the deformation ability and deformation recovery force of the flexible connection part 12 relative to the case body 11 may be improved, thereby improving the clarity and the tactile feel of the pressing and rebound operation of the first button part 13.

In some embodiments, the elasticity of the first button part 13 is smaller than the elasticity of the flexible connection part 12, which may solve the problem that the first button part 13 becomes deformed over long-term use and is unable to align properly with or match the function button 21 of the electronic device 20, resulting in reduced sensitivity or even failure. Furthermore, the hardness of the first button part 13 is greater than the hardness of the flexible connection part 12. In this way, wear resistance of the first button part 13 may be improved.

The case body 11 is configured to protect the electronic device 20, therefore, the case body 11 needs to have characteristics, such as impact resistance, wear resistance, and lightweight. The flexible connection part 12, as a rebound carrier of the first button part 13, needs to have high elasticity and high fatigue resistance. Therefore, by selecting more suitable materials for the case body 11 and flexible connection 12 according to different usage needs, and complementing the material properties of each part, the balance between functionality of the protective case 10 and user's experience may be maximized.

In some embodiments, the flexible connection part 12 is in a planar tension state and located in the opening 101. Compared to setting the flexible connection part 12 in a wrinkled shape, the rebound of the flexible connection part 12 in a planar tension state is clearer, which makes the pressing and rebound feedback effect for the first button part 13 more obvious, thereby providing a better pressing tactile feel.

In some embodiments, an extension direction of the flexible connection part 12 is consistent with an extension direction of an outer surface of the case body 11. In this way, the flexible connection part 12 may be in the planar tension state, which may improve the rebound effect of the flexible connection part 12 and further improve the pressing tactile feel of the first button part 13.

In some embodiments, the flexible connection part 12 is made of a light-transmitting material. This allows the flexible connection part 12 to transmit light, improving the visual effect of the protective case 10 in certain scenarios, such as when the function button 21 of the electronic device 20 is illuminated. In some embodiments, the flexible connection part 12 may also be made of an opaque material, or a light-shielding layer covers the outer surface of the flexible connection part 12.

In some embodiments, the first button part 13 further includes an outer surface layer, the outer surface layer forms the outer surface of the first button part 13, and a friction coefficient of the outer surface layer is less than a friction coefficient of the flexible connection part 12. The outer surface layer may be made of a material with a low friction coefficient, and the material is easy to slidably touch, such as an aramid fiber layer impregnated with a resin and polished, or a smooth and wear-resistant material such as sapphire glass, etc. The outer surface layer may also use some polymer materials with lower friction coefficients, which may be sprayed onto the outer surface of the first button part 13 to form the outer surface layer. By making the friction coefficient of the outer surface layer less than the friction coefficient of the flexible connection part 12, the frictional force may reduce when the user touches the first button part 13. In this way, the tactile feel at the first button part 13 is smoother and more fluid, which is conducive to improving the operational smoothness of the first button part 13 on the function button 21 of the electronic device 20. In some embodiments, the outer surface layer is made of the same material as the case body 11. In this way, the first button part 13 has a consistent appearance with the case body 11, improving the overall appearance consistency of the protective case 10.

Furthermore, both the outer surface layer and the case body 11 are made of the aramid fiber material. In this way, while ensuring the overall appearance consistency of the protective case 10, the outer surface layer and the outer surface of the case body 11 may have advantages, such as wear resistance, smoothness, and ease of slidably touching.

In some embodiments, the outer surface layer is a smooth layer, forming the outer surface of the first button part 13. The smooth layer may be made of the materials with a low friction coefficient that is easy to slidably touch. For example, the smooth layer may be made of the aramid fiber layer impregnated with a resin and polished, or a smooth and wear-resistant material such as sapphire glass, etc. The setting of the smooth layer may improve the operational smoothness of the first button part 13 on the function button 21 of the electronic device 20.

In some embodiments, the outer surface layer is a wear-resistant layer formed on the outer surface of the first button part 13. The wear-resistant layer may be made of a wear-resistant material, such as, aramid fiber, sapphire glass, etc. The setting of the wear-resistant layer may improve the scratch resistance of the first button part 13, thereby improving the appearance stability of the first button part 13.

The outer surface layer may be separately disposed as the smooth layer or the wear-resistant layer. Alternatively, the smooth layer and the wear-resistant layer are mixed as a smooth and wear-resistant layer. This may improve the operational smoothness of the first button part 13 on the function button 21 of the electronic device 20, or this may make the first button part 13 to have advantages, such as wear resistance, smoothness, and ease of slidably touching, all of which fall within the protection scope of this embodiment, and there is no specific limitation.

In some embodiments, a sensing button 211 of the electronic device 20 is located on the side surface, and in the assembled state, the position of the sensing button 211 corresponds to the position of the first button part 13 on the side wall 113 of the protective case 10. The sensing button 211 of the electronic device 20 protrudes from the side surface of the electronic device 20. In this way, a groove is defined between the inner surface of the first button part 13 and the inner surface of the case body 11, and the groove is configured for accommodating the protruding sensing button 211. The groove may also form a deformation space for the flexible connection part 12, so as to improve the operational reliability of the entire first button part 13.

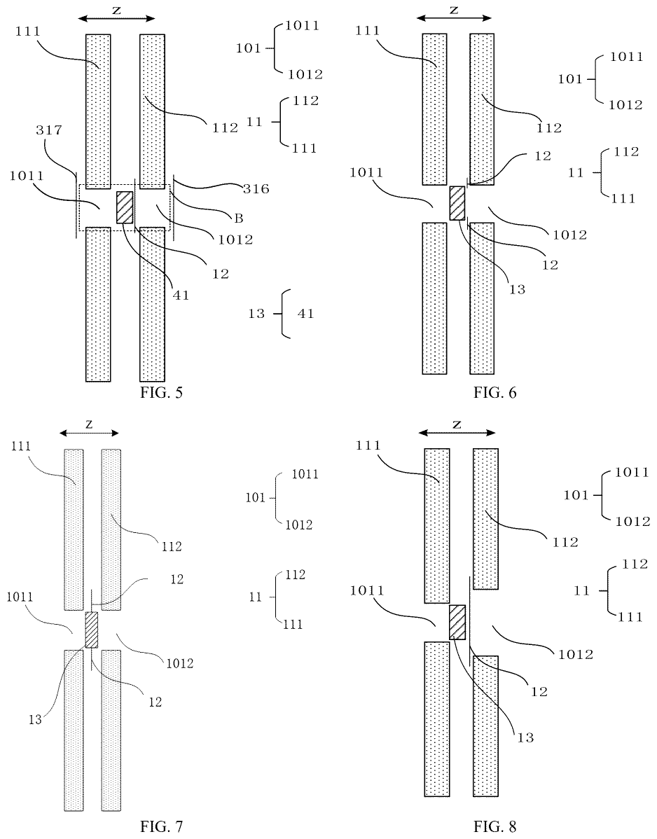

In some embodiments, as shown in FIGS. 5, 35, and 36, the first button part 13 includes a fiber layer 41.

In some embodiments, the first button part 13 is a single-layer structure that only includes a fiber layer 41, as shown in FIGS. 5 and 35. FIG. 5 shows a layered structure of partial structure of the protective case 10 before the molding process in an embodiment, and FIG. 35 shows a cross-sectional structure of partial structure of the protective case 10 after the molding process in an embodiment. The first button part 13 includes the single-layer fiber layer 41. In some embodiments, as shown in FIG. 36, FIG. 36 is a cross-sectional structural schematic view illustrating partial structure of the protective case 10 after the molding process in another embodiment. The first button part 13 includes a button body 131 and the fiber layer 41. The fiber layer 41 is disposed on or covers a side of the button body 131 away from the electronic device 20. The user may press the first button part 13 by pressing the fiber layer 41.

In this way, the fiber layer 41 may be utilized to improve the tactile feel of the first button part 13 and improve the user experience. Furthermore, the disposing of the fiber layer 41 facilitates improvement of the appearance of the first button part 13, which may improve the overall aesthetic appeal of the protective case 10.

In some embodiments, the fiber layer 41 may also encircle and envelop the outer periphery of the button body 131, or the fiber layer 41 may be disposed on an inner side and an outer side of the button body 131.

In some embodiments, as shown in FIG. 5, along the thickness direction z of the case body 11, the projection of the flexible connection part 12 covers the projection of the first button part 13 and the opening 101.

Along the thickness direction z of the case body 11, the projection of the flexible connection part 12 covers the projection of the first button part 13 and the opening 101, which means that the projection of the flexible connection part 12 in the thickness direction z of the case body 11 covers the projection of the first button part 13 and the opening 101, without limiting whether the first button part 13 is completely located in the opening 101.

The beneficial effect of the above setting is that the flexible connection part 12 covers the first button part 13 and the opening 101 in the thickness direction z, which facilitates the connection between the flexible connection part 12 and the side wall 113 of the opening 101, as well as the connection between the flexible connection part 12 and the first button part 13. It improves the connection stability between the flexible connection part 12 and the first button part 13. Moreover, the covering design of the flexible connection part 12 may effectively reduce interference from the external factor, such as dust on the first button part 13, improving the reliability of the first button part 13, and improving the protective effect of the protective case 10 on the electronic device 20.

In some embodiments, as shown in FIG. 6, along the thickness direction z of the case body 11, the flexible connection part 12 partially covers the first button part 13, so that the flexible connection part 12 is connected to the first button part 13. Alternatively, as shown in FIG. 7, along the thickness direction z of the case body 11, the flexible connection part 12 does not cover the first button part 13 and is connected to the outer periphery of the first button part 13. In some embodiments, the flexible connection part 12 fully or partially surrounds the outer periphery of the first button part 13, and the side of the flexible connection part 12 away from the first button part 13 is connected to the case body 11, thereby connecting the first button part 13 and the case body 11 into an integrated structure.

The improvement of the flexible connection part 12 is not limited to the embodiment where the case body 11 is a double-layer structure. In an embodiment where the case body 11 is a single-layer structure or a three-layer or more structure (not shown in the figures), the flexible connection part 12 may still be improved with reference to the embodiments shown in FIGS. 5 to 7.

In order to improve the structural stability of the protective case 10, the connection mode between the flexible connection part 12 and the case body 11 may also be improved. In some embodiments, as shown in FIG. 5, the case body 11 includes a first support layer 111 and a second support layer 112, and the first support layer 111 defines a first opening 1011. The second support layer 112 is stacked with at least a part of the first support layer 111 along the thickness direction z of the case body 11, and the second support layer 112 defines a second opening 1012. Along the thickness direction z, the first opening 1011 and the second opening 1012 at least partially overlap to form the opening 101. At least a part of the flexible connection part 12 is stacked between the first support layer 111 and the second support layer 112. The stiffness of the first support layer 111 and the stiffness of the second support layer 112 are both greater than the stiffness of the flexible connection part 12. In this way, the local resistance of the first support layer 111 and the second support layer 112 to external object invasion is greater than the local resistance of the flexible connection part 12 to the external object invasion. The first support layer 111 and the second support layer 112 together form the case body 11 of the protective case 10. The first support layer 111 and the second support layer 112 may be an outer layer material and an inner layer material that form the case body 11, respectively. The first support layer 111 and the second support layer 112 may be made of the materials with high stiffness, and the first support layer 111 and the second support layer 112 may be made of rigid thermosetting resin materials. The first support layer 111 and the second support layer 112 may also be made of materials with a certain degree of elasticity, such as silicone or TPU. In some embodiments, the first support layer 111 and the second support layer 112 may be made of aramid fiber materials. The aramid fiber material is woven from the aramid fibers. The aramid fiber material has high rigidity and hardness by impregnating the aramid fiber material with epoxy resin. The first support layer 111 and the second support layer 112 may be formed into the case body 11 by hot-pressing.

In some embodiments, the elasticity of the first support layer 111 and the elasticity of the second support layer 112 are less than the elasticity of the flexible connection part 12, which may make the flexible connection part 12 prone to deformation and recovery deformation, enabling operation of the electronic device 20 inside the protective case 10. The rigid layer is less prone to deformation, improving the protection effect on the electronic device 20.

The first opening 1011 completely overlaps or partially overlaps with the second opening 1012. At least partial overlap between the first opening 1011 and the second opening 1012 means that the projection of the opening 101 area of the first opening 1011 and the projection of the opening 101 area of the second opening 1012 at least partially overlaps along the thickness direction z, so as to reduce the obstruction of the second opening 1012 by the peripheral area of the first opening 1011 and the obstruction of the first opening 1011 by the peripheral area of the second opening 1012, so that the opening 101 of the case body 11 is formed at the overlapping part of the first opening 1011 and the second opening 1012. The opening 101 may be configured to dispose the first button part 13. The first support layer 111 completely overlaps or partially overlaps with the second support layer 112, and there is no specific limitation.

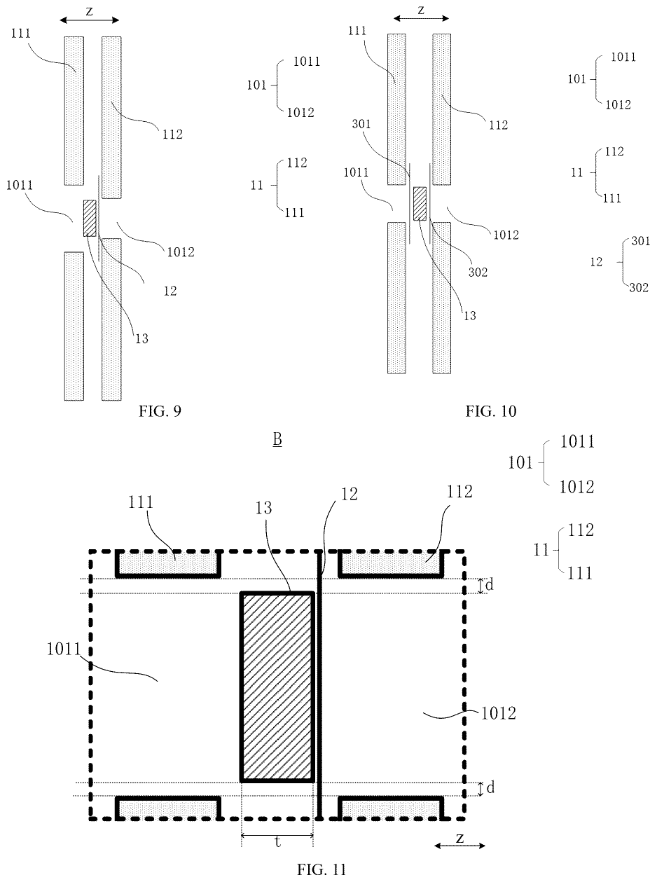

In some embodiments, as shown in FIG. 5, the first opening 1011 and the second opening 1012 have the same size and are completely aligned. The projection of the flexible connection part 12 along the thickness direction z covers the first opening 1011 and its peripheral area, as well as the second opening 1012 and its peripheral area. In some embodiments, as shown in FIG. 9, the size of the first opening 1011 is greater than the size of the second opening 1012, and the first opening 1011 and the second opening 1012 overlap at least partially along the thickness direction z. The projection of the flexible connection part 12 along the thickness direction z covers the first opening 1011 and its peripheral area, as well as the second opening 1012 and its peripheral area. In some embodiments, as shown in FIG. 8, the size of the first opening 1011 is less than the size of the second opening 1012, and the first opening 1011 and the second opening 1012 overlap at least partially along the thickness direction z. The projection of the flexible connection part 12 along the thickness direction z covers the first opening 1011 and its peripheral area, as well as the second opening 1012 and its peripheral area.

At least a part of the flexible connection part 12 is stacked between the first support layer 111 and the second support layer 112, which may fix the flexible connection part 12 through the first support layer 111 and the second support layer 112, achieving a tight combination of the flexible connection part 12 with the first support layer 111 and the second support layer 112, thereby improving the connection reliability between the flexible connection part 12 and the case body 11, and improving the positional stability and deformation controllability of the flexible connection part 12 when the flexible connection part 12 is subjected to the force. Furthermore, the flexible connection part 12 may be a TPU film layer, which may reduce the thickness of the flexible connection part 12, increase the deformation space for elastic deformation, thereby increasing the displacement distance of the first button part 13 when the first button part 13 is pressed, and improving the rebound force.

In some embodiments, when the flexible connection part 12 adopts other structural forms, similar improvements may also be made to the flexible connection part 12, so as to achieve a fixed connection between the flexible connection part 12 and the first support layer 111 and the second support layer 112 respectively, thereby achieving the connection between the flexible connection part 12 and the case body 11. Therefore, by designing a layered structure, the connection stability between the flexible connection part 12 and the case body 11 may be effectively improved, and it is convenient for subsequent processing.

In some embodiments, the case body 11 may also only include the first support layer 111. The first support layer 111 is stacked with at least a part of the flexible connection part 12, so that the flexible connection part 12 is tightly adhered with the first support layer 111 through hot-pressing or other molding processes.

In order to improve the connection stability between the flexible connection part 12 and the first button part 13, further improvements may be made to the flexible connection part 12. In some embodiments, as shown in FIG. 10, the flexible connection part 12 includes a first flexible layer 301 and a second flexible layer 302. Along the thickness direction z, the first flexible layer 301 is disposed on or covers the outer side of the first button part 13. Along the thickness direction z, the second flexible layer 302 is disposed on or covers the inner side of the first button part 13.

In some embodiments, the projection of the first flexible layer 301 in the thickness direction z of the case body 11 covers the first button part 13, and the projection of the second flexible layer 302 in the thickness direction z of the case body 11 covers the first button part 13. Along the thickness direction z of the case body 11, the first flexible layer 301, the first button part 13, and the second flexible layer 302 are stacked in sequence. The first flexible layer 301 and the second flexible layer 302 sandwich the first button part 13 in the middle through a stacked structure, which may improve the connection tightness between the first button part 13 and the flexible connection part 12, and provide better protection for the first button part 13, preventing the first button part 13 from shifting or getting damaged during use, thereby further improving the stability and durability of the overall structure. The second flexible layer 302 on the inner side of the first button part 13 may also help to reduce or eliminate marks left on the first button part 13 caused by long-term contact with the function button 21 of the electronic device 20.

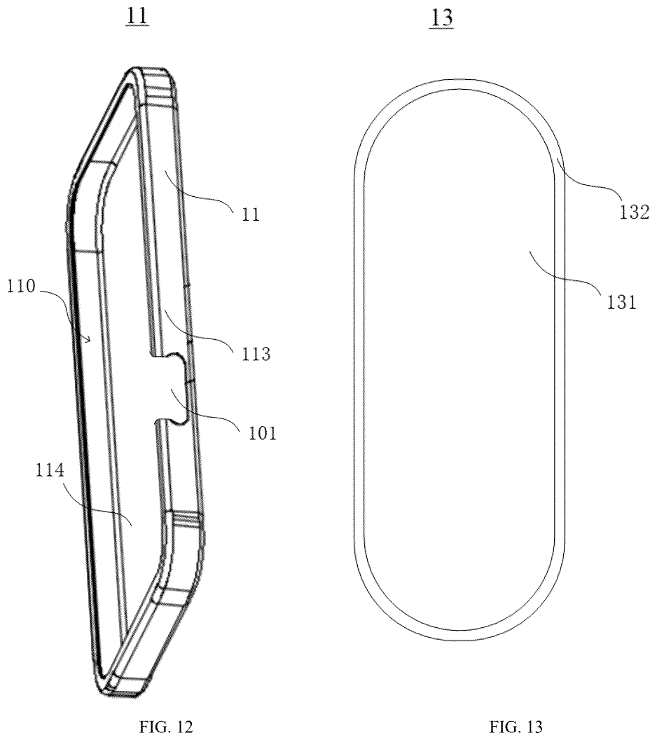

In some embodiments, as shown in FIG. 11, FIG. 11 is an enlarged structural schematic view of a B area of FIG. 5, there is a gap d between the first button part 13 and an inner wall of the opening 101.

The gap d is defined between the first button part 13 and the inner wall of the opening 101, which means that the projection of the first button part 13 along the thickness direction z of the case body 11 is located in the opening 101, and the gap d is defined between the projection and the inner wall of the opening 101. It may also be understood that in a plane perpendicular to the thickness direction z of the case body 11, the gap d is defined between the first button part 13 and the inner wall of the opening 101. When the first button part 13 is pressed along the thickness direction z, the gap d may provide a certain buffer space, reducing the collision and friction between the first button part 13 and the case body 11.

The first button part 13 may maintain a certain gap d with the inner wall of the opening 101 through the flexible connection part 12, ensuring the flexibility of the button operation, reducing the risk of button jamming, and reducing the friction between the first button part 13 and the case body 11 when the user performs the button operation.

In some embodiments, the first button part 13 is located in the opening 101, and a annular gap d is defined between an outer peripheral wall of the first button part 13 and the inner wall of the opening 101. The flexible connection part 12 is integrated with the first button part 13, so as to cover or fill the gap d. The design of the flexible connection part 12 covering or filling the first annular gap d may effectively reduce the interference of the external factor such as dust on the first button part 13, improve the reliability of the first button part 13, and improve the protective effect of the protective case 10 on the electronic device 20.

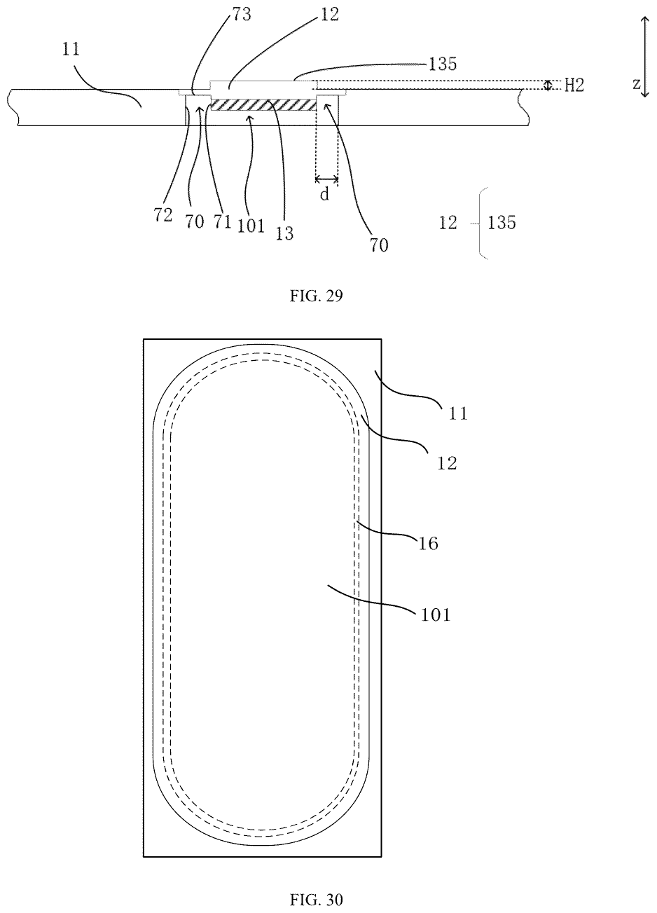

In some embodiments, as shown in FIG. 29, FIG. 29 is a cross-sectional structural schematic view illustrating partial structure of the protective case 10 after the molding process in an embodiment of the present disclosure. An inner wall 71 of the first button part 13, an inner wall 72 of the opening 101, and a part 73 of the flexible connection part 12 located in the gap form a groove 70. The groove 70 provides space for the deformation of the flexible connection part 12.

FIG. 29 shows a cross-sectional structure of partial structure of the protective case 10 after the molding process in an embodiment. By defining the groove 70, it is possible to provide deformation space for the flexible connection part 12, reduce the difficulty of user pressing, and provide a better button-press experience for the user.

In some embodiments, the flexible connection part 12 includes an annular area or a quasi-annular area covering the gap d.

In some embodiments, the projection of the flexible connection part 12 in the thickness direction z covers the gap d. The area where the flexible connection part 12 covers the gap d may be the annular area or the quasi-annular area, such as a square annulation, a circular annulation, etc., and there is no specific limitation. The covering design of the flexible connection part 12 may effectively reduce the interference of the external factor such as dust on the first button part 13, improve the reliability of the first button part 13, and improve the protective effect of the protective case 10 on the electronic device 20.

In some embodiments, the flexible connection part 12 has a sheet-like structure in the annular or quasi-annular area. In this way, the flexible connection part 12 may be tensioned and unfolded in a plane. Compared to setting the part of the flexible connection part 12 in the annular or quasi-annular area into the wrinkled shape, the rebound of the thin-sheet-like flexible connection part 12 is clearer. As a result, the first button part 13 provides a clearer pressing and rebound feedback, resulting in a better button-press tactile feel.

In some embodiments, the flexible connection part 12 may also be disposed in a wrinkled shape in the annular or quasi-annular area. In this way, the deformation range of the flexible connection part 12 may be increased.

In order to further improve the flexibility and stability of the button operation, in some embodiments, as shown in FIG. 11, a width of the gap d between the first button part 13 and the inner wall of the opening 101 ranges from 0.5 mm to 2 mm.

The width of gap d refers to a distance between the projection of the first button part 13 along the thickness direction z of the case body 11 towards the opening 101 and the inner wall 72 of the opening 101 in the plane perpendicular to the thickness direction z of the case body 11. In some embodiments, the case body 11 forms a closed opening 101, and the projection of the first button part 13 along the thickness direction z of the case body 11 towards the opening 101 is located in the opening 101. The gap d surrounds the first button part 13, so that the annular gap is defined between the first button part 13 and the inner wall 72 of the opening 101, and a width of the annular gap is the width of the gap d.

The larger the gap d, the more flexible the button operation. However, an excessively large gap d may lead to a decrease in the stability of the position of the first button part 13. When the gap d is too small, it may lead to an increase in friction, making the button operation too stiff, increasing friction, and affecting the user experience. Therefore, the width of the gap d is set to 0.5 mm, 0.6 mm, 0.7 mm, 0.8 mm,0.9 mm, 1.0 mm, 1.1 mm, 1.2 mm, 1.3 mm, 1.4 mm, 1.5 mm, 1.6 mm, 1.7 mm, 1.8 mm, 1.9 mm or 2.0 mm, etc., so as to improve the flexibility of button operation and the stability of the position of the first button part 13.

In some embodiments, the width of the gap d between the first button part 13 and the inner wall 72 of the opening 101 is 0.8 mm. This may further improve the comfort and durability of button operation, and the user may obtain the smooth feedback regardless of the different pressing forces applied.

In some embodiments, a ratio of the area of the flexible connection part 12 to the area of the first button part 13 at the gap d ranges from 0.3 to 3.35.

A peripheral area of the opening 101 is connected to the first button part 13 through the flexible connection part 12. The area of the flexible connection part 12 at the gap d refers to an area of the projection of the flexible connection part 12 at the gap d in the plane perpendicular to the thickness direction z of the case body 11. The area of the first button part 13 refers to an area of the projection of the first button part 13 in the plane perpendicular to the thickness direction z of the case body 11.

The area may be 0.3, 0.4, 0.55, 0.861, 0.945, 1, 1.02, 1.542, 1.6, 1.8, 2, 2.35, 2.5, 2.61, 3, 3.05, 3.1, 3.15, 3.2, 3.25, 3.3, 3.35, etc., and there is no specific limitation. In some embodiments, the area of the flexible connection part 12 at the gap d is 17.927 mm², the area of the first button part 13 is 31.14 mm², and the area ratio is 0.576. In some embodiments, the area of the flexible connection part 12 at the gap dis 81.13 mm², the area of the first button part 13 is 31.14 mm², and the area ratio is 2.605. In some embodiments, the area of the flexible connection part 12 at the gap d is 21.068 mm², the area of the first button part 13 is 68.565 mm², and the area ratio is 0.307. In some embodiments, the area of the flexible connection part 12 at the gap d is 93.698 mm², the area of the first button part 13 is 68.565 mm², and the area ratio is 1.367.

This setting may improve the flexibility of the button at the first button part 13, ensuring the button area of the first button part 13, providing better pressing tactile feel, improving the comfort and durability of the button operation, and providing a better button-press experience for the user.

In some embodiments, the thickness of the flexible connection part 12 at the gap d is less than the thickness of the first button part 13.

The thickness of the flexible connection part 12 refers to the thickness of the flexible connection part 12 in the thickness direction z of the case body 11, and the thickness of the first button part 13 refers to the thickness of the first button part 13 in the thickness direction z of the case body 11. The thickness of the flexible connection part 12 is less than the thickness of the first button part 13, which may further improve the flexibility of elastic deformation of the flexible connection part 12, thus improving the displacement flexibility of the first button part 13.

In some embodiments, the thickness of the flexible connection part 12 at the gap d may also be equal to the thickness of the first button part 13, so as to improve the thickness consistency of the overall structure of the protective case 10.

In some embodiments, the thickness of the flexible connection part 12 ranges from 0.1 mm to 0.5 mm.

In some embodiments, the thickness of the flexible connection part 12 at the gap d ranges from 0.1 mm to 0.5 mm.

In some embodiments, the thickness of the flexible connection part 12 at the gap d is 0.1 mm, 0.2 mm, 0.3 mm, 0.4 mm, or 0.5 mm, etc., so as to further improve the elastic deformation ability of the flexible connection part 12 and reduce the interference of the flexible connection part 12 on user operation.

In some embodiments, the first button part 13 is elongated, and the opening 101 and the first button part 13 are disposed to match the function button 21 of the electronic device 20.

The first button part 13 may be set in various shapes, such as circular, rectangular, racetrack-shaped, etc. The first button part 13 is disposed to match the function button 21 of the electronic device 20, making it easier for the user to identify and observe. The opening 101 and the first button part 13 are disposed to match the function button 21 of the electronic device 20, so that an extension shape of the gap d is consistent with an outer contour shape of the first button part 13, ensuring visual consistency. It may improve the force uniformity of the inner and outer rings of the flexible connection part 12.

In some embodiments, as shown in FIG. 4, a length h of the first button part 13 ranges from 15 mm to 19 mm.

The length h of the first button part 13 refers to a length of a long side of the first button part 13 in the plane perpendicular to the thickness direction z of the case body 11. In some embodiments, the first button part 13 is disposed on the side wall 113 of the case body 11. The first button part 13 is a quasi-rectangular structure with long sides and short sides, and the length h of the long side is 15 mm, 16 mm, 16.2 mm, 16.5 mm, 16.7 mm, 17 mm, 17.1 mm, 17.3 mm, 17.5 mm, 17.8 mm, 18 mm, or 19 mm, etc.

In some embodiments, the length h of the first button part 13 may be subject to minor adjustments based on the size of the function button 21 of the electronic device 20.

The length h of the first button part 13 is too long, which may affect the convenience of the user operation and make it difficult to accurately control the corresponding function button 21 of the electronic device 20 by pressing the first button part 13. When the length h of the first button part 13 is too short, the first button part 13 cannot effectively cover the area of the function button 21 of the electronic device 20, and it is not convenient for the user to perform the button operation. Therefore, the above setting may effectively improve the convenience of the user operation.

In some embodiments, the length h of the first button part 13 is 17.5 mm, allowing the user to accurately trigger the corresponding function button 21 of the electronic device 20 during operation, thereby improving the user experience.

In some embodiments, as shown in FIG. 4, a width w of the first button part 13 ranges from 1.5 mm to 4 mm.

The width w of the first button part 13 refers to the length of the short side of the first button part 13 in the plane perpendicular to the thickness direction z of the case body 11. In some embodiments, the first button part 13 is disposed on the side wall 113 of the case body 11. The first button part 13 is a quasi-rectangular structure with the long sides and the short sides, and the length of the short side is 1.5 mm, 1.8 mm, 2 mm, 2.1 mm, 2.3 mm, 2.5 mm, 3 mm, 3.2 mm, 3.3 mm, 3.5 mm, 3.6 mm, 3.7 mm, or 4 mm, etc.

In some embodiments, the width w of the first button part 13 may be subject to minor adjustments based on the size of the function button 21 of the electronic device 20.

The width w of the first button part 13 is too large, which may increase the overall size of the protective case 10 and make it inconvenient for the user to operate. When the width w of the first button part 13 is too small, the first button part 13 cannot effectively cover the area of the function button 21 of the electronic device 20. Therefore, the above settings may effectively improve the convenience of the user operation.

The length range and the width range of the first button part 13 mentioned above are the optimal range obtained through experiments, and some uncreative adjustments to the above range should also be in the protection scope of the present disclosure.

In some embodiments, the width of the annular or quasi-annular area, i.e., the width of the flexible connection part 12 at the gap d, ranges from 0.5 mm to 2 mm.

The larger the width of the annular or quasi-annular area, the more flexible the button operation. However, an excessively large width may lead to a decrease in the stability of the position of the first button part 13. When the width of the annular or quasi-annular area is too small, it may cause the button operation to be too stiff, increase friction, and affect the user experience. Therefore, the width of the annular or quasi-annular area is set to 0.5 mm, 0.55 mm, 0.7 mm, 0.85 mm, 0.9 mm, 1.0 mm, 1.15 mm, 1.2 mm, 1.3 mm, 1.45 mm, 1.5 mm, 1.6 mm, 1.75 mm, 1.8 mm, 1.95 mm, or 2.0 mm, etc., so as to improve the flexibility of the button operation and the stability of the position of the first button part 13.

In some embodiments, the width of the annular or quasi-annular area is 0.8 mm, so as to further improve the comfort and durability of the button operation, and the user may obtain the smooth feedback regardless of the different pressing forces applied.

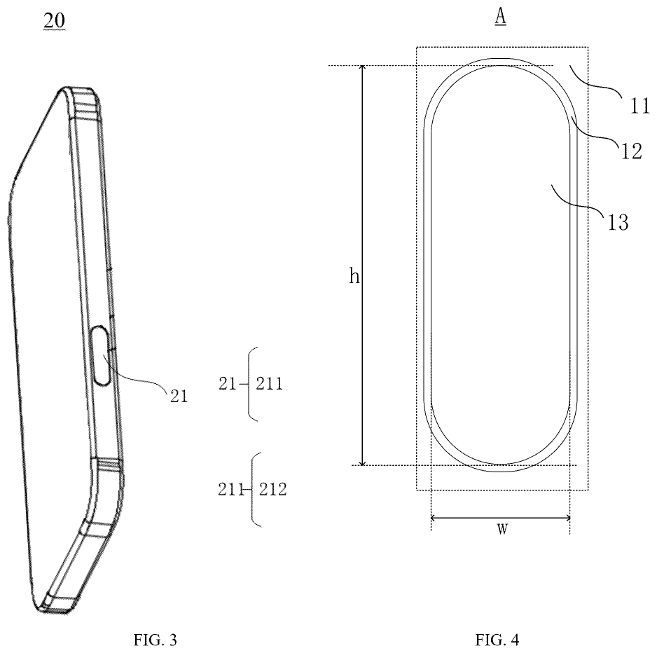

In some embodiments, as shown in FIG. 3, the protective case 10 is configured to protect the electronic device 20, the electronic device 20 is provided with the function button 21. When the electronic device 20 is assembled inside the protective case 10, the first button part 13 covers at least a part of the function button 21.

The first button part 13 covers at least a part of the function button 21, which means that after the protective case 10 is assembled with the electronic device 20, the projection of the first button part 13 along the thickness direction z of the case body 11 towards the electronic device 20 covers one or more (two or more) of multiple function buttons 21 of the electronic device 20, so that the first button part 13 corresponds to some of the function buttons 21.

In some embodiments, the first button part 13 is disposed at the position of the protective case 10 corresponding to the function button 21 of the electronic device 20. The first button part 13 is connected to or disposed in the opening 101 through the flexible connection part 12, therefore, the first button part 13 has a strong ability to undergo displacement under the external force. The first button part 13 may be capable of more quickly and accurately transmitting an external operation, thereby improving the sensitivity and reliability of the function button 21 when subjected to the external operation.

In some embodiments, when disassembling the protective case 10 from the electronic device 20, the disassembly operation may also be performed at the first button part 13, which may reduce the difficulty of disassembling the protective case 10 through the displacement of the first button part 13 and the deformation ability of the flexible connection part 12.

Compared to the solution of exposing the function button 21 of the electronic device 20 by defining a through hole in related art, the protective case 10 in some embodiments may cover the function button 21 of the electronic device 20 through the first button part 13 and the flexible connection part 12, so that the function button 21 is not exposed, providing protection for the function button 21. Moreover, by disposing the protective case 10, the interference of the protective case 10 on the user's operation of the function button 21 may be reduced.

In some embodiments, the function button 21 includes a sensing button 211. The sensing button 211 may be a touch sensitive sensing button 211, so that the user may manipulate or retrieve corresponding function of the electronic device 20 by touching the sensing button 211, such as a shooting function, or a near field communication (NFC) function, etc.

In some embodiments, the sensing button 211 is disposed in the outer surface of the electronic device 20. The first button part 13 is attached to the outer surface of the sensing button 211 and configured to protect the sensing button 211, which may allow the user to operate the sensing button 211 by touching the first button part 13.

The sensing button 211 may include a capacitive sensing button 211 or a resistive sensing button 211, etc.

In some embodiments, the sensing button 211 includes the capacitive sensing button 211. The deformability of the flexible connection part 12 and the displaceability of the first button part 13 may be utilized to transmit the external pressing operation to the capacitive sensing button 211, thereby achieving the first function control of the electronic device 20 through the pressing operation. Even if the first button part 13 is an insulator, there may still be a capacitive coupling effect between the user or other conductors and the capacitive sensing button 211. Therefore, when the user or other conductors move relative to the first button part 13, one or both of the coupling capacitance value and the coupling position of the capacitive sensing button 211 may change. This enables the electronic device 20 to conveniently recognize the user's or other conductors' operations on the capacitive sensing button 211, thereby achieving a second function operation of the electronic device 20. The first function and the second function mentioned above may be two different functions of the electronic device 20, or they may be different operations of the same function of the electronic device 20.

In some embodiments, the sensing button 211 may be the resistive sensing button 211. The deformability of the flexible connection part 12 and the displaceability of the first button part 13 may be utilized to transmit the external pressing operation to the resistive sensing button 211, thereby achieving the control for the electronic device 20 through the pressing operation. Different functions of the electronic device 20 may be controlled through parameters, such as different pressing durations.

In some embodiments, the multiple function buttons 21 of the electronic device 20 may be implemented through a combination of the capacitive sensing buttons 211, the resistive sensing buttons 211, etc.

In some embodiments, as shown in FIG. 3, the electronic device 20 includes the mobile phone, and the sensing button 211 includes a shooting button 212. The protective case 10 is provided with the side wall 113 that is configured for surrounding the side of the mobile phone, the first button part 13 is provided on the side wall 113, and the shooting button 212 is located on the inner side surface of the first button part 13.

In some embodiments, a display surface of the mobile phone is defined as a front face. When the display surface faces the user, the side surface away from the user is defined as the back face. The bottom wall 114 of the protective case 10 corresponds to the back face of the mobile phone. The first button part 13 corresponds to the shooting button 212 of the mobile phone, so as to operate the shooting button 212 through the first button part 13.

In some embodiments, in order to improve the convenience of the mobile phone operation, the function button 21 of the mobile phone is usually disposed on a right side of the mobile phone (when the mobile phone is in its default screen display mode), and the first button part 13 of the protective case 10 is disposed on a right wall of the protective case 10, so that the first button part 13 corresponds to the function button 21 of the mobile phone. The function button 21 includes the sensing button 211, and the sensing button 211 includes the shooting button 212 configured for implementing the mobile phone's photography function. The shooting button 212 is electrically connected to the main control of the electronic device 20, such as a microprocessor unit. The shooting button 212 may convert the user's pressing and touching operations on the shooting button 212 into electrical signals, and transmit the electrical signals to the microprocessor unit, so that the microprocessor unit may control a camera component and other related function components of the electronic device 20 to operate, thereby achieving at least one of the functions, such as camera opening and closing, focal length adjustment, shooting, and video recording, etc.

In some embodiments, the first button part 13 may also be disposed corresponding to other function buttons 21 of the electronic device 20. The function buttons 21 may be the sensing button 211 or a press button. The function buttons 21 may also achieve functions, such as power on/off, volume adjustment, screenshot, etc.

In some embodiments, as shown in FIG. 11, the thickness t of the first button part 13 ranges from 0.1 mm to 1.2 mm.

The thickness t of the first button part 13 is less than or equal to 1.2 mm. On the one hand, the space of the opening 101 of the protective case 10 is limited. As the thickness of the first button part 13 decreases, more space becomes available for the displacement of the first button part 13. This is conducive to effectively transmitting the pressing operation through the first button part 13. The less the thickness of the first button part 13, the lower the overall resistance of the first button part 13, reducing an operating distance between the user and the electronic device 20, and reducing the interference of the first button part 13 of the protective case 10 on the user's operation of the electronic device 20, thus improving the sensitivity and reliability of the user's operation of the electronic device 20. On the other hand, the thickness t of the first button part 13 is greater than or equal to 0.1 mm, which may improve the protection capability of the first button part 13 for the function button 21, also increase the service life of the first button part 13, and reduce the risk of the first button part 13 breaking during operation.

In some embodiments, the thickness t of the first button part 13 may be 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, etc.

The first button part 13 is attached to the surface of the sensing button 211 of the electronic device 20. It may limit the effective usable thickness range of the first button part 13, allowing the user to conveniently operate the sensing button 211 of the electronic device 20 through the protective case 10.

In some embodiments, as shown in FIGS. 2 and 3, the case body 11 includes the side wall 113 and the bottom wall 114. The side wall 113 is disposed on the outer periphery of the bottom wall 114, so that the side wall 113 jointly encloses with the bottom wall 114 to form the accommodation chamber 110 that is configured to accommodate the electronic device 20. The opening 101 is defined on the side wall 113 or the bottom wall 114.

When the electronic device 20 is assembled inside the protective case 10, the back face of the electronic device 20 is attached to the bottom wall 114 of the case body 11, and the side surface of the electronic device 20 is attached to the side wall 113 of the case body 11.

In some embodiments, the opening 101 is defined on the side wall 113, at least one function button 21 of the electronic device 20 is disposed on the side surface, and the first button part 13 is disposed at the opening 101.

In some embodiments (not shown in the figures), the opening 101 is defined on the bottom wall 114, at least one function button 21 of the electronic device 20 is disposed on the back face, and the first button part 13 is disposed at the opening 101, making it convenient for the user to directly press the first button part 13 at the opening 101 on the bottom wall 114 of the case body 11, so as to control the function button 21.

In some embodiments, as shown in FIG. 12, FIG. 12 is a structural schematic view of another embodiment of the case body in the present disclosure, the opening 101 is defined on the side wall 113, and the opening 101 penetrates or extends through the side of the side wall 113 away from the bottom wall 114.

The opening 101 is an open-type opening 101. In some embodiments, the side wall 113 of the case body 11 includes a first side connected to the bottom wall 114 of the case body 11 and a second side away from the bottom wall 114 of the case body 11. The opening 101 is defined on the side wall 113, and the opening 101 penetrates or extends through the second side of the side wall 113 of the case body 11, forming the open-type opening 101, so that an edge of the side wall 113 of the case body 11 forms a notch.

In some embodiments, as shown in FIG. 2, the opening 101 is defined in a middle area of the side wall 113, so that the side wall 113 surrounds the opening 101.

The opening 101 is a closed-type opening 101. The area surrounding the opening 101 is the case body 11 with greater rigidity, which may increase the connection area between the flexible connection part 12 and the case body 11, improve the stability of the connection between the flexible connection part 12 and the case body 11, thereby improving the stability of the connection between the first button part 13 and the case body 11.

In some embodiments, when the electronic device 20 is assembled inside the protective case 10, the projection of the first button part 13 towards the electronic device 20 covers the function button 21 of the electronic device 20 and at least a part of a peripheral area of the function button 21.

In order to further provide a better button-press experience for the user, in some embodiments, as shown in FIG. 13, FIG. 13 is a structural schematic view of an embodiment of the first button part 13 in the present disclosure, the first button part 13 includes the button body 131 and an elastic body 132 disposed around the outer periphery of the button body 131. The elasticity of the button body 131 is greater than the elasticity of the elastic body 132, so as to increase the rebound force of the button body 131 through the elastic body 132, making the feedback of the first button part 13 pressing rebound clearer.

In some embodiments, the elastic body 132 provides a full-surrounding enclosure for the first button part 13, improving the overall stability and durability of the button. In some embodiments (not shown in the figures), the elastic body 132 partially surrounds the first button part 13, such as semi-enclosing or intermittent surrounding manner, etc.

The beneficial effect of the above setting is that the combination design of the button body 131 and the elastic body 132 may improve the resilience of the first button part 13 when the first button part 13 is pressed, thereby improving the user's button-press feel.

In some embodiments, the first button part 13 includes the button body 131 and the elastic body 132 disposed on the button body 131. In the assembled state of the protective case 10 and the electronic device 20, the elastic body 132 is located on the side of the button body 131 close to the electronic device 20, which may improve the rebound effect of the first button part 13 when the first button part 13 is pressed.

The elastic body 132 may operate together with the flexible connection part 12, so as to achieve the press-and-rebound function of the first button part 13. In some embodiments, the flexible connection part 12 connects the first button part 13 and the protective case 10, and the elastic body 132 is connected to the flexible connecting part 12. In some embodiments, the elastic body 132 may be tightly connected to the flexible connection part 12 through the hot-pressing process.

In some embodiments, there may not be the flexible connection part 12, and the elastic body 132 may be connected between the first button part 13 and the case body 11, so as to achieve the press-and-rebound function of the first button part 13.

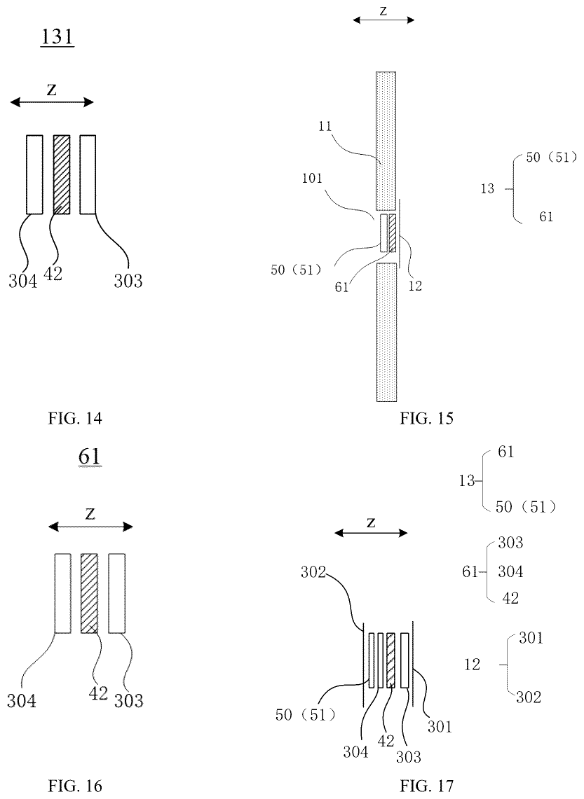

In some embodiments, as shown in FIG. 14, FIG. 14 is a structural schematic view of an embodiment of the button body 131 in the present disclosure. The button body 131 includes a third flexible layer 303, the fiber layer 42, and a fourth flexible layer 304 stacked in sequence along the thickness direction z.

In some embodiments, in the thickness direction z of the case body 11, the third flexible layer 303, the fiber layer 42, and the fourth flexible layer 304 are stacked in sequence. This layered structure may improve the structural strength of the button body 131, achieve the shaping of the fiber layer 42, preventing the fiber layer 42 from deforming and preventing the fiber bundles that form the fiber layer 42 from becoming loose and separating. In some embodiments, the third flexible layer 303 is disposed on or covers one side of the fiber layer 42, and the fourth flexible layer 304 is disposed on or covers the other side of the fiber layer 42. That is, the projection of the third flexible layer 303 and the projection of the fourth flexible layer 304 along the thickness direction z of the case body 11 cover the fiber layer 42, so as to improve the positioning effect.

The size relationship between the third flexible layer 303, the fiber layer 42, and the fourth flexible layer 304 is not limited. In some embodiments, the projections of the third flexible layer 303, the fiber layer 42, and the fourth flexible layer 304 along the thickness direction z of the case body 11 completely overlap and have the same size. In some embodiments (not shown in the figures), the sizes of the projections of the third flexible layer 303, the fiber layer 42, and the fourth flexible layer 304 along the thickness direction z of the case body 11 may also be set to be different. In some embodiments, the projections of the third flexible layer 303 and the fourth flexible layer 304 are both greater than the projection of the fiber layer 42, and the projection of the fiber layer 42 is completely covered.

Furthermore, the stiffness of fiber layer 42 is greater than the stiffness of the third flexible layer 303 and the stiffness of the fourth flexible layer 304. In this way, while effectively protecting the fiber layer 42, the plastic deformation ability of the entire first button part 13 is improved, avoiding deformation of the first button part 13 after long-term use.

In some embodiments, the elastomer 132 includes a TPU elastic ring, the third flexible layer 303 and the fourth flexible layer 304 are both the TPU films, and the fiber layer 42 is the aramid fiber.

The TPU elastic ring has excellent wear resistance and tear resistance, and may maintain good elasticity and stability in long-term use. The TPU elastic ring may be transparent or dark black, which not only looks beautiful, but also matches the colors of various casings of the electronic device 20, improving the overall visual effect. The high resilience of TPU elastic ring may effectively the buffer button pressure and extend their service life. The TPU elastic ring may adapt to various environments and is not easily aged. Moreover, the lightweight nature of the TPU material reduces device burden and improve portability.

The elastic body 132 may also be formed from other types of high elasticity polymer materials in related art, such as silicone or rubber, etc.

The third flexible layer 303 and the fourth flexible layer 304 are both the TPU films. The TPU film has excellent characteristics, such as good transparency, good molding, high melting point, and good connectivity with other film layers. The TPU film may reduce the difficulty of molding processes, improve the reliability and the aesthetic appeal, and improve the visibility and excellent texture of the fiber layer 42. Therefore, choosing the TPU film as the third flexible layer 303 and the fourth flexible layer 304, it is only necessary to improve the color and appearance of the fiber layer 42 to achieve an improvement in the appearance of the button body 131. This may improve the convenience of production and design.

The aramid fiber has high strength, high modulus, high temperature resistance, corrosion resistance and other characteristics, which may effectively improve the structural strength and durability of the button body 131, ensuring that the button body 131 has stable performance even under frequent pressing. The lightweight and soft characteristics of the aramid fiber may further optimize the tactile feel and rebound effect of the button, improving the user experience.

In some embodiments, the fiber layer 42 may increase the flexibility of the button body 131, and the fiber layer 42 may improve the close fit between the button body 131 and the buttons of the electronic device 20. The fiber layer 42 includes but is not limited to the aramid fibers, such as aramid dry fibers or aramid fibers impregnated in thermoplastic resin, or other types of fiber materials known in the related art.

In some embodiments, the fiber layer 42 includes a composite layer of the aramid fibers and TPU. The aramid fibers pre-impregnated with the thermoplastic resin (such as polyurethane) may be used as the fiber layer 42 after molding, or aramid cloth fibers and TPU that are stacked may be used as the fiber layer 42.

The fiber layer 42 may also be pre-impregnated with the epoxy resin. The aramid fiber layer pre-impregnated with the epoxy resin may reduce the material's flexibility and increase the material's stiffness, as well as improve other physical properties such as wear resistance and impact resistance. The fiber layer 42 may not be pre-impregnated by the epoxy resin, so as to maintain its soft characteristics. All of the above treatment methods fall within the protection scope of the present disclosure.

In order to improve the operational sensitivity when the user or other conductors operate the sensing button 211 of the electronic device 20 through the first button part 13, the following improvements may also be made to the first button part 13. In some embodiments, as shown in FIG. 15, FIG. 15 is a structural schematic view of yet another embodiment of partial structure of the protective case 10 in the present disclosure. The first button part 13 includes a conductive layer 50, an outer side surface of the conductive layer 50 is covered by the flexible connection part 12, and the conductive layer 50 is located at least at the opening 101.

In the present disclosure, the inner side or the inner side surface of the first button part 13 and its related structures refers to the side of the protective case 10 that is close to the electronic device 20 when the protective case 10 is assembled with the electronic device 20. The outer side or the outer side surface of the first button part 13 and its related structures refers to the side of the protective case 10 that is away from the electronic device 20 and close to the user or other conductors when the protective case 10 is assembled with the electronic device 20.

The conductive layer 50 is a layered conductive structure, and may be a single-layer structure or a multi-layer composite structure. The conductive layer 50 is mainly configured to provide conductivity and form coupling capacitance with the user's fingers and the sensing button 211.

In the assembled state of the protective case 10 and the electronic device 20, the conductive layer 50 is disposed close to the electronic device 20, and the outer side surface of the conductive layer 50 is covered by the flexible connection part 12. The outer side surface of the conductive layer 50 is covered by the flexible connection part 12, which means that the projection of the flexible connection part 12 along the thickness direction z of the case body 11 towards the electronic device 20 completely covers the conductive layer 50. In some embodiments, when the user or other conductors operate the sensing button 211 of the electronic device 20 through the first button part 13, the conductor and the conductive layer 50 are separated by the flexible connection part 12. Therefore, the coupling capacitance may be formed between the conductor and the conductive layer 50, and the coupling capacitance may be formed between the conductive layer 50 and the sensing button 211 of the electronic device 20, thereby forming the series capacitance, so as to achieve capacitive sensing. Furthermore, the flexible connection part 12 is provided with the conductive layer 50 on the side away from the conductor and close to the sensing button 211. The conductor is close to the sensing button 211, which may improve the conductivity of the inner side surface of the first button part 13 and improve the user's operational sensitivity to the sensing button 211.

In some embodiments, as shown in FIG. 15, the first button part 13 further includes a first body layer 61, the first body layer 61 is disposed on the outer side of the conductive layer 50, and the outer side surface of the first body layer 61 is covered by the flexible connection part 12.

The first button part 13 at least includes the first body layer 61 and the conductive layer 50. In the assembled state of the protective case 10 and the electronic device 20, the conductive layer 50 is disposed close to the electronic device 20, and the first body layer 61 is disposed on the outer side surface of the conductive layer 50. The outer side surface of the first body layer 61 is further covered by the flexible connection part 12. In some embodiments, the projection of the flexible connection part 12 along the thickness direction z of the case body 11 towards the electronic device 20 completely covers the first body layer 61. The first body layer 61 may be made of a wear-resistant material, such as the aramid fibers or the aramid fibers impregnated in thermoplastic resin.

The first body layer 61 is disposed between the flexible connection part 12 and the conductive layer 50. The first body layer 61 may provide protection for the conductive layer 50. Disposing the first body layer 61 may improve the structural strength of the first button part 13, and prevent wear or damage to the conductive layer 50 due to long-term use.

In some embodiments, the outer side surface of the conductive layer 50 may be further covered by the first body layer 61. The projection of the first body layer 61 along the thickness direction z of the case body 11 towards the electronic device 20 completely covers the conductive layer 50. This setting may further improve the protective effect of the first body layer 61 on the conductive layer 50. Furthermore, when the flexible connection part 12 is made of the transparent material, the first body layer 61 may visually cover the conductive layer 50. Improving the first body layer 61 may improve the appearance of the first button part 13, thus improving the convenience of production design.

In some embodiments, the flexible connection part 12 may not cover the first body layer 61 and may be connected to the first body layer 61.

In some embodiments, as shown in FIG. 16, FIG. 16 is a structural schematic view of an embodiment of a first body layer 61 in the present disclosure, the first body layer 61 includes the third flexible layer 303, the fiber layer 42, and the fourth flexible layer 304 stacked in sequence along the thickness direction z.

In some embodiments, in the thickness direction z of the case body 11, the third flexible layer 303, the fiber layer 42, and the fourth flexible layer 304 are stacked in sequence. This stacked structure may improve the structural strength of the first body layer 61, achieve the shaping of the fiber layer 42, and prevent deformation and looseness of the fiber layer 42. In some embodiments, the third flexible layer 303 is disposed on or covers one side of the fiber layer 42, and the fourth flexible layer 304 is disposed on or covers the other side of the fiber layer 42. That is, the projections of the third flexible layer 303 and the fourth flexible layer 304 along the thickness direction z of the case body 11 cover the fiber layer 42, so as to improve the positioning effect.

The size relationship between the third flexible layer 303, the fiber layer 42, and the fourth flexible layer 304 is not limited. In some embodiments, the projections of the third flexible layer 303, the fiber layer 42, and the fourth flexible layer 304 along the thickness direction z of the case body 11 completely overlap and have the same size. In some embodiments (not shown in the figures), the sizes of the projections of the third flexible layer 303, the fiber layer 42, and the fourth flexible layer 304 along the thickness direction z of the case body 11 may also be set to be different. In some embodiments, the projections of the third flexible layer 303 and the fourth flexible layer 304 are both greater than the projection of the fiber layer 42, and the projection of the fiber layer 42 is completely covered.

In some embodiments, the third flexible layer 303 and the fourth flexible layer 304 are both TPU film layers, and the fiber layer 42 is made of the aramid fibers. The fiber layer 42 may also be made of other known types of fiber materials in the related art.

The third flexible layer 303 and the fourth flexible layer 304 are both second TPU film layers. The specific implementation and operation principle of the second TPU film layer may refer to the first TPU film layer, which may not be repeated here.

The aramid fiber has high strength, high modulus, high temperature resistance, corrosion resistance and other characteristics, which may effectively improve the structural strength and durability of the button body 131, ensuring that the button body 131 has stable performance even under frequent pressing. The lightweight and soft characteristics of the aramid fiber may further optimize the tactile feel and rebound effect of the button, improving the user experience.

In order to improve the operational sensitivity and operational experience when the user or other conductors operate the sensing button 211 of the electronic device 20 through the first button part 13, the following improvements may also be made to the conductive layer 50 of the first button part 13. In some embodiments, the conductive layer 50 includes a conductive film layer 51.

The conductive film layer 51 refers to a thin film of conductive material with a relatively small thickness, which may reduce the physical barrier between the user's finger and the sensing button 211 of the electronic device 20. This allows for more intuitive feedback and a more sensitive touch when the user presses or slides the first button part 13. Additionally, the conductive film layer 51 has the flexible characteristics similar to a thin film, which enables the conductive film layer 51 to closely adhere to the deformed flexible connecting part 12 when the user slides or presses. This prevents the sensation from feeling too rigid or the feedback from being delayed due to excessive rigidity.

The conductive film layer 51 may improve the tactile feel of the user when the user presses or slides the first button part 13.

In some embodiments, the electric conductivity of the conductive film layer 51 ranges from 10\hat{ }6 Ω to 10\hat{ }12 Ω.

The higher the electric conductivity, the more it may affect the user's touch accuracy. The electric conductivity is too low, and the sensitivity of the sliding operation may be affected when the user slides on the first button part 13 to control the sensing button 211 of the electronic device 20. Therefore, setting the electric conductivity to be greater than or equal to 10\hat{ }6 Ω and less than or equal to 10\hat{ }12 Ω may improve touch accuracy and sensitivity of the sliding operation. In some embodiments, the electric conductivity is set to 10\hat{ }6 Ω, 10\hat{ }7 Ω, 10\hat{ }8 Ω, 10\hat{ }9 Ω, 10\hat{ }10 Ω, 10\hat{ }11 Ω, or 10\hat{ }12 Ω, etc.

In some embodiments, the conductive film layer 51 is a TPU conductive film layer 51. The TPU conductive film layer 51 is a conductive film layer composed of TPU material and conductive fillers (such as conductive carbon nanotubes, conductive graphene, conductive silver nanowires, etc.). The TPU conductive film layer 51 has excellent conductivity, wear resistance, flexibility, hydrolysis resistance, weather resistance, as well as good processing performance and environmental friendliness. The TPU conductive film layer 51 may maintain stable in various environments and is easy to produce and process.

In order to improve the operational sensitivity and operational experience when the user or other conductors operate the sensing button 211 of the electronic device 20 through the first button part 13, the following improvements may also be made to the first button part 13 and the flexible connection part 12. In some embodiments, the conductive layer 50 includes the conductive film layer 51. As shown in FIG. 17, FIG. 17 is a structural schematic view of yet another embodiment of partial structure of the protective case 10 in the present disclosure. The flexible connection part 12 is a double-layer structure, including the first flexible layer 301 and the second flexible layer 302. The first body layer 61 includes the third flexible layer 303 and the fiber layer 42. Along the thickness direction z, the first flexible layer 301, the third flexible layer 303, the fiber layer 42, the conductive film layer 51, and the second flexible layer 302 are stacked in sequence. The first flexible layer 301 is disposed on or covers the outer side of the third flexible layer 303, and the second flexible layer 302 is disposed on or covers the inner side of the conductive film layer 51.

This stacking arrangement may further improve the structural strength of the first button part 13. The setting of the conductive film layer 51 may improve the response speed and tactile feel of the button.

The first flexible layer 301 is disposed to cover the outer side of the third flexible layer 303, and the second flexible layer 302 is disposed to cover the inner side of the conductive film layer 51. That is, the projections of the first flexible layer 301 and the second flexible layer 302 along the thickness direction z of the case body 11 completely cover the first body layer 61 and the conductive layer 50. This may improve the protective effect of the flexible connection part 12 (i.e., the first flexible layer 301, the second flexible layer 302) on the first button part 13 (i.e., the first body layer 61 and the conductive layer 50) as a whole, and improve the positional stability of the first button part 13.

The size relationship between the third flexible layer 303, the fiber layer 42, and the conductive layer 50 is not limited. In some embodiments, the projections of the third flexible layer 303, the fiber layer 42, and the conductive layer 50 along the thickness direction z of the case body 11 completely overlap and have the same size. In some embodiments (not shown in the figures), the sizes of the projections of the third flexible layer 303, the fiber layer 42, and the conductive layer 50 along the thickness direction z of the case body 11 may also be set to be different. In some embodiments, the projections of the third flexible layer 303 and the conductive layer 50 are both greater than the projection of the fiber layer 42, and the projection of the fiber layer 42 is completely covered.

In some embodiments, as shown in FIG. 17, the first body layer 61 further includes the fourth flexible layer 304, and the fourth flexible layer 304 is stacked between the conductive film layer 51 and the fiber layer 42.

The fourth flexible layer 304 is disposed or added, the fiber layer 42 may be fixed through the fourth flexible layer 304 and the third flexible layer 303. During the processing, hot-pressing parameters for bonding between the conductive film layer 51 and the fiber layer 42 are different from hot-pressing parameters for bonding between the fiber layer 42 and the fourth flexible layer 304 or the third flexible layer 303. The fourth flexible layer 304, the fiber layer 42, and the third flexible layer 303 are first laminated by hot-pressing. And then the conductive film layer 51 is attached or disposed.

This stacking arrangement may further improve the structural strength of the first button part 13. The setting of the conductive film layer 51 may improve the response speed and tactile feel of the button.

In some embodiments, the fourth flexible layer 304 is stacked between the conductive film layer 51 and the fiber layer 42, and the projection of the fourth flexible layer 304 along the thickness direction z of the case body 11 completely covers the fiber layer 42, which may further improve the structural stability of the first body layer 61.

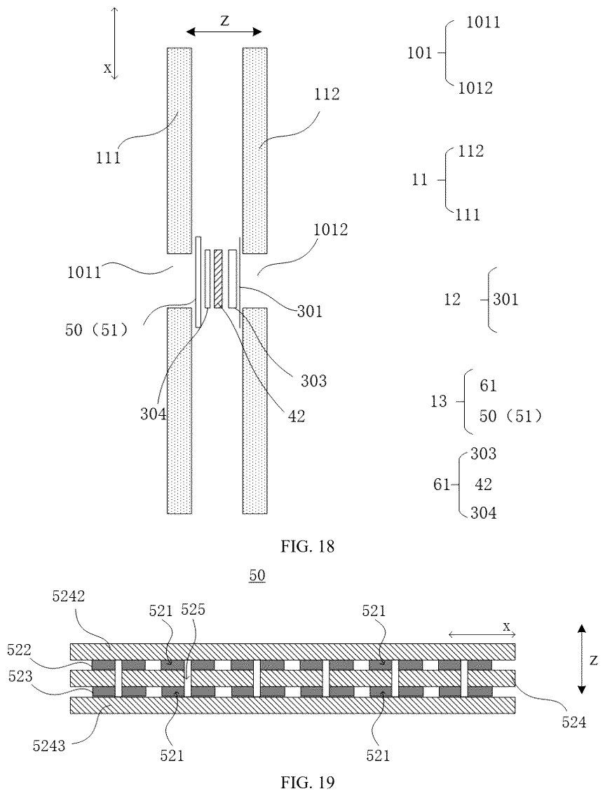

In order to improve the operational sensitivity and operational experience when the user or other conductors operate the sensing button 211 of the electronic device 20 through the first button part 13, the following improvements may also be made to the first button part 13 and the flexible connection part 12. In some embodiments, as shown in FIG. 18, FIG. 18 is a structural schematic view of yet another embodiment of partial structure of the protective case 10 in the present disclosure, the conductive layer 50 includes the conductive film layer 51. The first body layer 61 includes the third flexible layer 303, the fiber layer 42, and the fourth flexible layer 304 stacked in sequence along the thickness direction z. The flexible connection part 12 is a single-layer structure, including the first flexible layer 301. Along the thickness direction z, the first flexible layer 301, the third flexible layer 303, the fiber layer 42, the fourth flexible layer 304, and the conductive film layer 51 are stacked in sequence. The first flexible layer 301 is disposed on or covers the outer side of the third flexible layer 303, and the conductive film layer 51 is disposed on or covers the inner side of the fourth flexible layer 304 and extends to the peripheral area of the opening 101 on the case body 11.

The first flexible layer 301 is disposed on or covers the outer side of the third flexible layer 303, and the conductive film layer 51 is disposed on or covers the inner side of the fourth flexible layer 304. This means that the projection of the first flexible layer 301 along the thickness direction z of the case body 11 covers the third flexible layer 303, and the projection of the conductive film layer 51 along the thickness direction z of the case body 11 covers the fourth flexible layer 304. The protection and positioning of the first body layer 61 may be achieved through the flexible connection part 12 (i.e., the first flexible layer 301) and the conductive layer 50.

In some embodiments, the conductive film layer 51 extends to the peripheral area of the opening 101 on the case body 11, which may connect the conductive film layer 51 with the peripheral area of the opening 101, thus improving the positional stability of the conductive film layer 51. The first body layer 61 may be further connected to the peripheral area of the opening 101 through the conductive film layer 51, improving the positional stability and reliability of the first body layer 61, reducing the risk of movement of the conductive film layer 51 during the molding process, and thus improving the molding efficiency and reliability of the protective case 10 after molding.

In some embodiments, when the conductive layer 50 is a circuit board or other structures, a structure layout similar to the conductive film layer 51 described above may also be adopted to achieve the stacked arrangement of the first body layer 61, the flexible connection part 12, and the conductive layer 50, so as to improve the first button part 13 and the flexible connection part 12.

In some embodiments, the conductive layer 50 may include the circuit board, and the circuit board may include a printed circuit board (PCB) or a flexible printed circuit (FPC).

The advantage of the printed circuit board lies in its ability to accurately identify the touch position of the user or other conductor on the first button part 13 through the structural design of the circuit board, which may further improve the accuracy of touch control. In some embodiments, the circuit board is designed with a capacitive array or capacitive sensing area. When the user touches it, the circuit board may accurately identify the touch position by sensing changes in the electric field. Moreover, by enabling capacitive sensing between the circuit board and the function button 21 of the electronic device 20, the accuracy of touch control is improved.

In some embodiments, as shown in FIG. 19, the conductive layer 50 includes multiple conductive areas 521 that are electrically insulated from one another along a first direction x. The first direction x is along or parallel to a length direction of the first button part 13.

The length direction of the first button part 13 refers to the extension direction of the long side of the first button part 13 in the plane perpendicular to the thickness direction z of the case body 11. The user may slide or tap the first button part 13 along its length direction. Designing according to a specific insulation layout may accurately improve the conductive layer 50′s ability to capture and identify the specific tap position of the user or other conductor, thereby improving the control accuracy when the user operates the sensing button 211 of the electronic device 20 through the first button part 13.

The conductive areas 521 are segmented inside the first button part 13. After the protective case 10 is assembled with the electronic device 20, the first button part 13 is close to or in contact with the sensing button 211. When the user or other conductors touch the first button part 13, the coupling capacitance may be formed between the conductive area 521 and the conductor (human body), and the coupling capacitance may be formed between the conductive area 521 and the sensing button 211. These two coupling capacitances may be considered to be connected in series, thus forming the series capacitance between the conductor and the sensing button 211. During the movement of the conductor along the first direction x, it may form series capacitances with the multiple segmented conductive areas 521 in sequence. In actual use, when the user slides their finger, the finger (or the conductor) forms a series capacitance with the corresponding conductive area 521 at the corresponding position. The chip accurately identifies and locates the position of the finger by sensing the capacitance change at the corresponding position.

Furthermore, the setting of the flexible connection part 12 facilitates the transmission of the pressing of the conductor to the sensing button 211, so as to achieve the pressing operation of the sensing button 211.

In some embodiments, the multiple conductive areas 521 are spaced apart to achieve electrical insulation. In some embodiments, insulation tape may be disposed between adjacent conductive areas 521. In some embodiments, high impedance insulation ink (such as UV insulation ink, epoxy resin, or silicone coating) is disposed, to form the insulation tape, which may effectively improve the accuracy of touch signal recognition during use. In some embodiments, the electrical insulation may also be achieved through other means.

In some embodiments, as shown in FIG. 19, the conductive layer 50 is a multi-layer structure, and the conductive layer 50 includes a first conductive layer 522, an insulation layer 524, and a second conductive layer 523 that are stacked along the thickness direction z. The first conductive layer 522 is electrically connected to the second conductive layer 523 through a conductive component (not shown) disposed in a via 525 of the insulation layer 524.

The first conductive layer 522, the insulation layer 524, and the second conductive layer 523 are stacked in sequence. The electrical connection between the first conductive layer 522 and the second conductive layer 523 may be achieved through the via 525 in the insulation layer 524, without the need for additional wiring. The structure is simple, and the size of the circuit board may be reduced.

The first conductive layer 522 and the second conductive layer 523 include multiple conductive areas 521 that are electrically insulated from one another along the first direction x. One conductive area 521 located in the first conductive layer 522 is electrically connected to another corresponding conductive area 521 located in the second conductive layer 523 through the conductive component in the via 525.

In some embodiments, referring to FIG. 19, multiple conductive areas 521 of the first conductive layer 522 and the second conductive layer 523 are correspondingly arranged along the thickness direction z of the case body 11. In some embodiments, the first conductive layer 522 includes multiple conductive areas 521 spaced apart, the second conductive layer 523 includes multiple conductive areas 521 spaced apart. The projections of multiple conductive areas 521 of the second conductive layer 523, along the thickness direction z of the case body 11, are in one-to-one correspondence with and overlap, the projections of multiple conductive areas 521 of the first conductive layer 522 along the thickness direction z of the case body 11.

In some embodiments, when manufacturing the first conductive layer 522 and the second conductive layer 523, photolithography or chemical etching processes may be used to etch out spacing areas on the conductive layers. This ensures that each conductive area 521 is electrically insulated from one another. The projections of the conductive areas of the first conductive layer 522 along the thickness direction z, are in one-to-one correspondence with and overlap, the projections of the conductive areas of the second conductive layer 523 along the thickness direction z. In this way, the shape and spacing of the conductive area 521 may be precisely controlled, optimizing touch signal recognition.

In some embodiments, the conductive layer 50 further includes a second insulation layer 5242 and a third insulation layer 5243. The second insulation layer 5242 is disposed on a side of the first conductive layer 522 away from the insulation layer 524, and the third insulation layer 5243 is disposed on a side of the second conductive layer 523 away from the insulation layer 524. The second insulation layer 5242 and the third insulation layer 5243 protect the first conductive layer 522 and the second conductive layer 523, respectively, improving the durability and stability of the conductive layer 50. By this layered design, the conductive layer 50 improves touch accuracy and operational reliability while maintaining a compact structure.

In some embodiments, one or more of the insulation layer 524, the second insulation layer 5242, and the third insulation layer 5243 may be a flexible insulation layer, such as a PI film, a PET film, or a PEN film, etc. The first conductive layer 522 and the second conductive layer 523 may be a copper foil structure or a graphene film structure.

The insulation material may be actively filled between adjacent conductive areas 521, or the insulation layer may fill the gap between adjacent conductive areas 521 during the hot-pressing process.

In the above embodiments, the combination of conductive layer and the fiber layer solves the technical problem of insensitive touch through the fiber layer due to poor conductivity of the fiber layer.

In some embodiments, the first body layer 61 includes a rigid fiber layer, and the rigid fiber layer may be made of the fibers impregnated with thermosetting resin.

In some embodiments, the rigid fiber layer may be formed by aramid fiber material impregnated with epoxy resin after molding, which may improve the structural stability of the first body layer 61. This structure does not require an additional shaping film layer and is less prone to looseness and deformation.

In some embodiments, the rigid fiber layer includes a composite layer of aramid fibers and thermosetting resin. The aramid fibers pre-impregnated with thermosetting resin (such as epoxy resin) may be used as the rigid fiber layer after molding. In some embodiments, the material of the rigid fiber layer may also be artificial fibers such as carbon fiber, glass fiber or the like, metal, rigid plastic, inorganic materials such as silicide, etc.

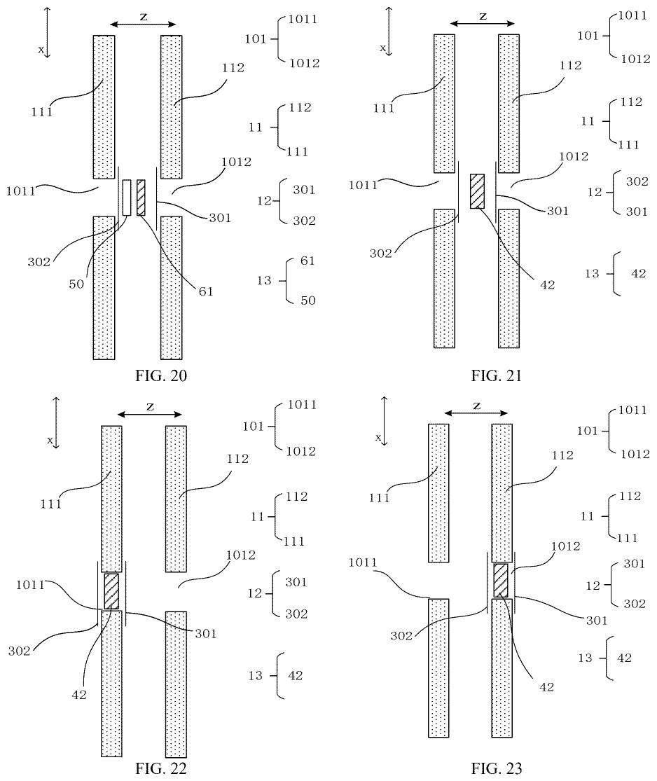

In some embodiments, as shown in FIG. 20, FIG. 20 is a structural schematic view of yet another embodiment of partial structure of the protective case 10 in the present disclosure. The first body layer 61 includes the rigid fiber layer, and the flexible connection part 12 is a double-layer structure, including the first flexible layer 301 and the second flexible layer 302. Along the thickness direction z, the first flexible layer 301, the rigid fiber layer, the conductive layer 50, and the second flexible layer 302 are stacked in sequence. The first flexible layer 301 is disposed on or covers the outer side of the rigid fiber layer, and the second flexible layer 302 is disposed on or covers the inner side of the conductive layer 50.

The first flexible layer 301 is disposed on or covers the outer side of the rigid fiber layer, and the second flexible layer 302 is disposed on or covers the inner side of the conductive layer 50, which may protect the rigid fiber layer and the conductive layer 50 and improve the structural strength. This covering design may increase the connection area between the first flexible layer 301 and the rigid fiber layer, and the connection area between the second flexible layer 302 and the conductive layer 50, improve the connection stability, and thus improve the positional stability of the first button part 13 when the first button part 13 is pressed. In some embodiments, the rigid fiber layer is formed by impregnating aramid fibers in epoxy resin.

In some embodiments, when the conductive layer 50 is the conductive film layer 51 or other structures, a similar structural layout as described above may also be adopted to achieve a stacked arrangement of the rigid fiber layer, the first flexible layer 301, the second flexible layer 302, and the conductive layer 50.

In some embodiments, when the first body layer 61 includes the fiber layer, a structural layout similar to the rigid fiber layer described above may also be adopted to achieve a layered arrangement of the fiber layer, the fourth flexible layer 304, the first flexible layer 301, and the conductive layer 50.

The second flexible layer 302 on the inner side of the conductive layer 50 may also help to reduce or eliminate the marks left on the conductive layer 50 caused by long-term contact with the functional buttons 21 of the electronic device 20.

In some embodiments, as shown in FIG. 21, the first button part 13 includes the fiber layer 42, and the flexible connection part 12 is a double-layer structure, including the first flexible layer 301 and the second flexible layer 302. Along the thickness direction z, the first flexible layer 301, the fiber layer 42, and the second flexible layer 302 are stacked in sequence. Along the thickness direction z, the projection of the first flexible layer 301 and the projection of the second flexible layer 302 cover the opening 101 and the peripheral area of the opening 101.

In some embodiments, the projection of the first flexible layer 301 and the projection of the second flexible layer 302 both cover the first opening 1011 and its peripheral area, as well as the second opening 1012 and its peripheral area.

The projection of the first flexible layer 301 and the projection of the second flexible layer 302 cover the opening 101 and the peripheral area of the opening 101, which may achieve connection and fixation between the first flexible layer 301 and the peripheral area of the opening 101, connection and fixation between the second flexible layer 302 and the peripheral area of the opening 101. The first flexible layer 301, the fiber layer 42, and the second flexible layer 302 are stacked in sequence, which may achieve the positioning of the fiber layer 42 through the first flexible layer 301 and the second flexible layer 302, and reduce the risk of position deviation of the fiber layer 42 in the molding process. The first flexible layer 301 and the second flexible layer 302 have a protective effect on the fiber layer 42.

In some embodiments, the projections of the first flexible layer 301 and the second flexible layer 302 along the thickness direction z of the case body 11 cover the fiber layer 42, so as to further improve the protective and positioning effects on the fiber layer 42.

In some embodiments, as shown in FIG. 22, FIG. 22 is a structural schematic view of yet another embodiment of partial structure of the protective case 10 in the present disclosure. The fiber layer 42 is disposed in the first opening 1011. Along the thickness direction z, the second flexible layer 302 is located on the side of the first support layer 111 away from the second support layer 112, and the first flexible layer 301 is located between the first support layer 111 and the second support layer 112. Both the first flexible layer 301 and the second flexible layer 302 extend to the peripheral area of the first opening 1011.

This setting may improve the positional stability of the first flexible layer 301 and the second flexible layer 302 through the first support layer 111 and the second support layer 112, thereby improving the positioning effect of the first flexible layer 301 and the second flexible layer 302 on the fiber layer 42, and reducing the risk of displacement of the first button part 13 when the first button part 13 is pressed.

The first flexible layer 301 and the second flexible layer 302 may also be disposed in other ways. In some embodiments, as shown in FIG. 23, FIG. 23 is a structural schematic view of yet another embodiment of partial structure of the protective case 10 in the present disclosure. The fiber layer 42 is disposed in the second opening 1012. Along the thickness direction z, the first flexible layer 301 is located on the side of the second support layer 112 away from the first support layer 111, and the second flexible layer 302 is located between the first support layer 111 and the second support layer 112. Along the thickness direction z, the projection of the first flexible layer 301 and the projection of the second flexible layer 302 cover the peripheral area of the second opening 1012.

In some embodiments, as shown in FIG. 21, the first flexible layer 301 and the second flexible layer 302 are located between the first support layer 111 and the second support layer 112.

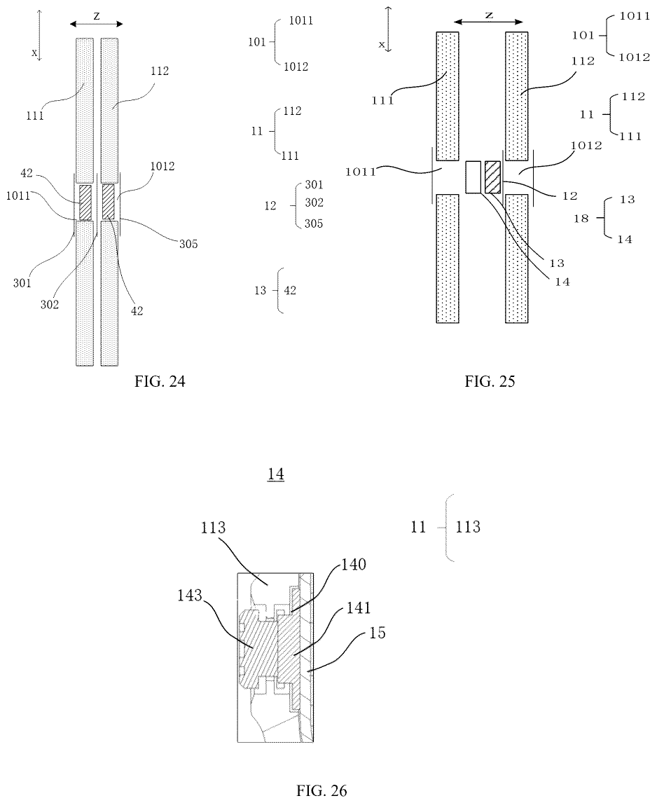

In some embodiments, as shown in FIG. 24, FIG. 24 is a structural schematic view of yet another embodiment of partial structure of the protective case 10 in the present disclosure. The first button part 13 includes two fiber layers 42. The flexible connection part 12 is a three-layer structure, including the first flexible layer 301, the second flexible layer 302, and a fifth flexible layer 305. One fiber layer 42 is located in the first opening 1011, and the other fiber layer 42 is located in the second opening 1012. Along the thickness direction z, the first flexible layer 301, the first support layer 111, the second flexible layer 302, the second support layer 112, and the fifth flexible layer 305 are stacked in sequence. The first flexible layer 301 and the second flexible layer 302 both cover one fiber layer 42 and extend to the peripheral area of the first opening 1011. The second flexible layer 302 and the fifth flexible layer 305 both cover another fiber layer 42 and extend to the peripheral area of the second opening 1012.

The fifth flexible layer 305 may be improved by referring to the second flexible layer 302, which may not be repeated here.

The positioning and protection of one fiber layer 42 are achieved through the second flexible layer 302 and the fifth flexible layer 305, and the positioning and protection of the other fiber layer 42 are achieved through the first flexible layer 301 and the second flexible layer 302. In some embodiments, the protective case 10 is formed by double body layers and double rigid layers, which may improve the overall stiffness of the protective case 10. Each of the two fiber layers 42 is located in the opening 101 of the corresponding rigid layer, which may reduce the overall thickness. By setting the positioning film layer as described above, the risk of displacement of the body layer during the molding process may be reduced, thereby improving the molding efficiency and the reliability of the protective case 10 after molding.

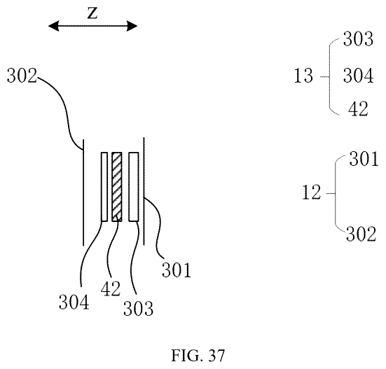

In order to improve the operational sensitivity and operational experience when the user or other conductors operate the sensing button 211 of the electronic device 20 through the first button part 13, the following improvements may also be made to the first button part 13 and the flexible connection part 12. In some embodiments, as shown in FIG. 37, the first button part 13 includes the third flexible layer 303, the fiber layer 42, and the fourth flexible layer 304. The flexible connection part 12 is a double-layer structure, including the first flexible layer 301 and the second flexible layer 302. Along the thickness direction z of the case body 11, the first flexible layer 301, the third flexible layer 303, the fiber layer 42, and the fourth flexible layer 304, and the second flexible layer 302 are stacked in sequence.

In some embodiments, the first button part 13 includes the third flexible layer 303, the fiber layer 42, and the fourth flexible layer 304, which may prevent deformation and looseness of the fiber layer 42 and facilitate processing. The first button part 13 is integrated with the case body 11 through the first flexible layer 301 and the second flexible layer 302, which may improve the positional stability of the first button part 13. In some embodiments, the projections of the first flexible layer 301 and the second flexible layer 302 toward the thickness direction z of the case body 11 cover the opening 101 and the peripheral area of the opening 101, so as to improve the positioning effect of the first button part 13.

In order to further improve the multi-scenario adaptability of the protective case 10 and improve the user experience, in some embodiments, as shown in FIG. 25, FIG. 25 is a structural schematic view of yet another embodiment of partial structure of the protective case 10 in the present disclosure. The protective case 10 further includes a second button part 14, the second button part 14 is located on the inner side of the first button part 13 and located at the opening 101. The second button part 14 is configured for data communication with the electronic device 20 assembled on the protective case 10 under the triggering of the first button part 13.

In the assembled state of the protective case 10 and the electronic device 20, the second button part 14 is disposed on the inner side of the first button part 13. That is, the second button part 14 is disposed on the side of the first button part 13 close to the electronic device 20.

In some embodiments, the user may trigger the second button part 14 by pressing the first button part 13, thereby enabling data communication with the electronic device 20 assembled inside the protective case 10 through this button operation.

In some embodiments, when the back face of the electronic device 20 is provided with or includes a sensing area, the second button part 14 is located at least at the opening 101 and may be triggered by the first button part 13. A functional component of the second button part 14 extends at least to the corresponding position where the case body 11 abuts against or is adjacent to the sensing area of the electronic device 20. In the assembled state, the position of the functional component of the second button part 14 corresponds to the position of the sensing area of the electronic device 20. Therefore, by pressing the first button part 13, the user may trigger the functional component of the second button part 14, thereby achieving data communication with the sensing area on the back face of the electronic device 20. In some embodiments, the first button part 13 may be disposed on the side wall 113 of the case body 11, therefore, there is no need to define a hole in the bottom wall 114 of the case body 11, the sensing area on the back face of the electronic device 20 may be triggered. This setting may improve the flexibility and diversity of the user waking up or operating the electronic devices 20 through the protective case 10, thereby improving the user experience.

In some embodiments, the protective case 10 defines multiple openings 101 and is provided with multiple corresponding first button parts 13. Each first button part 13 corresponds to one of different sensing buttons 211 of the electronic device 20. The inner side of at least one first button part 13 is provided with a corresponding second button part 14. This setting may further improve the multi-scenario adaptability of the protective case 10, and improve the flexibility and operational convenience of the user waking up or triggering the electronic device 20 through the protective case 10.

In some embodiments, the second button part 14 includes a near field communication (NFC) assembly.

The NFC assembly may achieve near-field communication. In this way, the user may trigger NFC function by pressing the first button part 13 of the protective case 10, and communicate with the corresponding assembly of the electronic device 20 through the NFC assembly, thereby enabling wake-up or operation of the electronic device 20.

The NFC is a short-range, high-frequency wireless communication technology that enables non-contact interaction between devices through electromagnetic induction coupling. The NFC assembly may be disposed in a thin sheet shape, adhered to the curved surface inside the protective case 10, or embedded in the button area through miniaturized packaging. The NFC assembly may be triggered through pressing a physical button or through touch.

In some embodiments, the user may trigger the NFC function by pressing the first button part 13 of the protective case 10, thereby enabling communication between the NFC assembly and the electronic device 20, and thus enabling wake-up or operation of the electronic device 20. In some embodiments, when the user presses the button, the mechanical switch closes or the sensor detects a pressure signal, and the pressure signal is transmitted to the microcontroller (such as MCU) inside the protective case 10, triggering the NFC function activation command. The electronic device 20 reads the data sent by the NFC assembly and performs the corresponding operation. Compared to the traditional protective case where the NFC assembly is mostly disposed independently, in this embodiment, the NFC assembly is integrated into the button and may trigger the NFC function (such as press-to-pay) when the button is pressed, reducing additional operation steps and improving user convenience. Secondly, compared to the always-on NFC assembly that is continuously in a readable state, the function of the NFC assembly in this embodiment is activated under control, which may reduce the frequency of accidental triggering during non-active operation. Moreover, the press-to-trigger mechanism provides position perception of the NFC function through the physical touch of the button, so that the user may locate the operating area without visual confirmation, making the operation more convenient and controllable. In addition, this design fully utilizes the internal space inside the button, avoiding the need for additional openings or thickening in other areas of the protective case 10, resulting in a more compact overall structure of the protective case 10.

In some embodiments, the user may trigger the NFC function by touching the first button part 13 of the protective case 10. In some embodiments, the button area (the first button part 13) of the protective case 10 is provided with a capacitive touch sensor. When the user's finger touches the button, the sensor detects a change in capacitance, generates an electrical signal, and transmits the electrical signal to the MCU inside the protective case 10, triggering a preset logic (such as activating NFC function). The electronic device 20 reads the data sent by the NFC assembly and performs a corresponding operation (such as launching an application, connecting a device). This embodiment does not require physical pressing, a light touch may trigger the function, providing a more sensitive user experience.

The second button part 14 may also implement wireless communication function by using Bluetooth, RFID, ZIGBEE, a combination of the above-mentioned technologies, or a combination of the above-mentioned technologies with NFC technology.

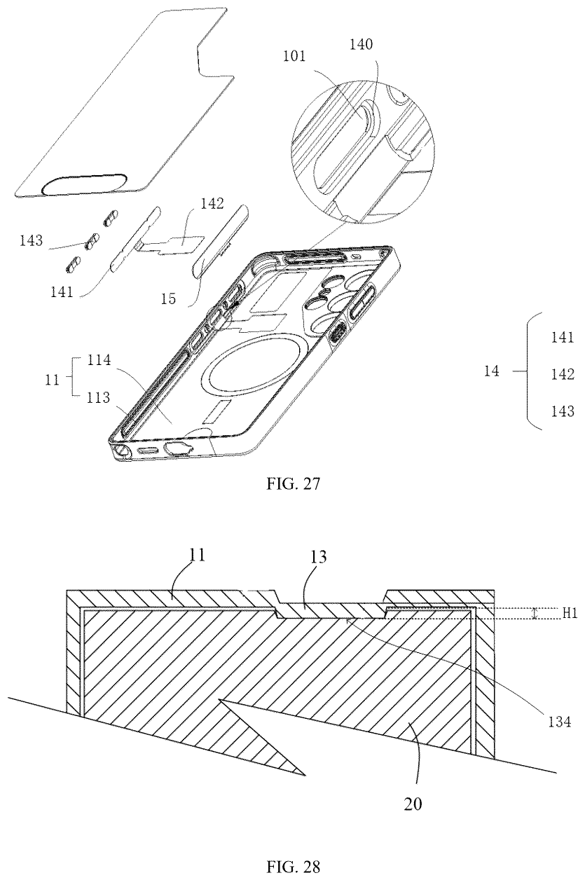

In some embodiments, as shown in FIGS. 26 and 27, FIG. 26 is a structural schematic view of an embodiment of a second button part 14 in the present disclosure, and FIG. 27 is an exploded structural schematic view of an embodiment of partial structure of the protective case 10 in the present disclosure. The NFC assembly includes an electronic trigger 141 and a functional device 142. The electronic trigger 141 is configured to be electrically connected to the functional device 142. The first button part 13 abuts against the electronic trigger 141 under the external force, thereby triggering the functional device 142.

In some embodiments, the electronic trigger 141 is a triggering device configured to receive the mechanical pressure or the capacitance change and convert them into an electrical signal. The electronic trigger 141 is connected to the functional device 142, so as to activate the NFC function. The electronic trigger 141 may be mechanical, such as conductive rubber or a metal spring plate. The electronic trigger 141 may also be inductive, outputting a pressure threshold signal through a pressure-sensitive layer and signal processing circuit. In some embodiments, in the thickness direction z of the case body 11, the electronic trigger 141 is disposed corresponding to the first button part 13. In this way, by manipulating the first button part 13, the electronic trigger 141 may be directly triggered, thereby activating the NFC function of the electronic device.

The functional device 142 is an electronic module that performs the NFC function. After receiving a signal from the electronic trigger 141, it initiates communication or performs a preset operation. The functional device 142 typically includes a signal input interface connected to the electronic trigger 141, a logic control unit that is configured for determining a trigger condition, and a communication unit that is configured for sending preset data to an external card reader.

The electronic trigger 141 and the functional device 142 may be directly integrated and installed, such as soldering the electronic trigger 141 (such as a micro switch, a capacitive sensor) and the functional device 142 on the same PCB. Alternatively, they may be designed as independent function modules, embedded into the reserved slots of the protective case 10 through mechanical connection modes such as a snap-fit or a sliding rail, facilitating maintenance and replacement in the future. The electronic trigger 141 and the functional device 142 may also be installed separately. For example, the electronic trigger 141 and the functional device 142 are separately placed, and the electronic trigger 141 and the functional device 142 are connected through the flexible circuit board (FPC) or ribbon cable, so as to adapt to the curved surface of the case or a movable part. Alternatively, magnetic contacts (such as pogo pins) may be disposed on the electronic trigger 141 and the functional device 142, so as to achieve physical contact and signal conduction through magnetic attraction.

In some embodiments, when the case body 11 includes the side wall 113 and the bottom wall 114, and the first button part 13 is disposed on the side wall 113, the electronic trigger 141 is disposed on the side wall 113 of the case body 11 and corresponds to the first button part 13. The functional device 142 is disposed on the bottom wall 114. The electronic devices usually have an NFC sensing area on the back face. By placing the functional device 142 on the bottom wall 114 of the case body 11, it may correspond to the NFC sensing area on the back face of the electronic device. Therefore, the first button part 13 on the side of the case body 11 may trigger the NFC sensing area on the back face of the electronic device 20, which may improve the flexibility and diversity of the user to wake up or operate the electronic device 20 through the protective case 10, thereby improving the user experience.

In some embodiments, the electronic trigger 141 includes the circuit board and a switch element, and the functional device 142 includes an FPC coil electrically connected to the circuit board.

The shape of the circuit board may be rectangular, circular, or polygonal, etc., so as to adapt to the internal space layout of the device. The material of the circuit board may be a FR-4 epoxy resin substrate (a conventional PCB material) or a flexible substrate (such as polyimide, suitable for bending requirements). The circuit board may adopt a double-layer or multi-layer wiring structure, so as to integrate a power interface, a signal processing unit (such as a MCU chip), and a solder pad.

The switch element may be selected from a tactile switch, a thin-film switch, a pressure sensor, or the like according to a triggering mode. The shape of the switch element may be selected from a miniature surface-mount type or a cylindrical button. When the user touches the first button part 13, the capacitive sensor detects and outputs the signal, the signal unit of NFC receives the signal and sends the preset data, and then the mobile phone receives the data and responds. In some embodiments, the user may touch the button, so that NFC sends a Bluetooth pairing command, thereby enabling the mobile phone to automatically connect to other electronic devices. When the user touches the first button part 13, the switch closes and the circuit is connected, activating the NFC function and sending data to the mobile phone. The mobile phone responds after receiving the data. In some embodiments, the user may press the button, so that the NFC sends pre-stored payment card information, and the mobile phone may then bring up the payment interface.

In some embodiments, the protective case 10 also has a charging function. In this case, the NFC assembly may be configured to control whether to charge or not.

The electronic trigger 141 may be configured to start or activate the functional device 142. In some embodiments, the electronic trigger 141 may be a component with piezoelectric sensing function. When the electronic trigger 141 is pressed, the electrical signal is generated, thereby activating the functional device 142.

The beneficial effect of the above settings is that the functional device 142 may be triggered through simple button operation, making it easy to operate and providing a good user experience. According to the requirements of different application scenarios, different types of functional devices 142 may be designed, so as to improve the multi-scenario applicability of the protective case 10. In some embodiments, through special design of functional device 142, the user may trigger the preset operation through the NFC, such as launching the application, launching a mini-program, connecting to WIFI, switching a mode, turning on a flashlight, controlling a smart home device, etc.

In some embodiments, the functional device 142 includes a coil. The coil may be a PCB coil, a Litz wire coil, or a FPC coil.

The functional device 142 may be the FPC coil that may be connected to the circuit board. The FPC coil is lightweight and flexible, and may be bent to adapt to or fit an irregular surface, making the overall structure of the device compact.

In some embodiments, as shown in FIG. 26, the second button part 14 further includes a pressing part 143, and the pressing part 143 is disposed between the NFC assembly and the first button part 13.

The user may indirectly trigger the pressing part 143 by pressing the first button part 13, thereby activating the NFC assembly and achieving communication with the electronic device 20.

In some embodiments, as shown in FIGS. 26 and 27, the inner side wall of the case body 11 defines a limit groove 140 that is communicated with the opening 101, and the electronic trigger 141 is limited to the case body 11 through the limit groove 140.

In some embodiments, the bottom of the limit groove 140 defines a through hole that is communicated with the opening 101. Therefore, by pressing the first button part 13 at the opening 101, the electronic trigger 141 may be directly triggered, achieving the triggering of the second button part 14. Furthermore, the electronic trigger 141 is limited to the limit groove 140, which may improve the positional stability of the electronic trigger 141, reduce device displacement caused by frequent operation, and ensure that each pressing may accurately trigger the functional device 142.

In some embodiments, as shown in FIG. 26, the protective case 10 further includes a packaging cover plate 15, and the packaging cover plate 15 is connected to the side of the electronic trigger 141 away from the first button part 13. The packaging cover plate 15 is installed on the inner side wall 113 of the case body 11 and covers the limit groove 140.

The packaging cover plate 15 is installed on the inner side wall 113 of the case body 11 and covers the limit groove 140, which means that the packaging cover plate 15 is disposed on the side of the protective case 10 close to the electronic device 20.

The packaging cover plate 15 provides support for the NFC assembly, so that the NFC assembly stably undergoes displacement along the pressing direction, without deviating in other directions. This setting may effectively improve the position stability and reliability of the electronic trigger 141. Specifically, the installation of the packaging cover plate 15 may effectively protect the electronic trigger 141, prevent dust and moisture from entering the limit groove 140, and ensure that the electronic trigger 141 maintains efficient response during long-term use.

In order to further reduce the size of the protective case 10, similar improvements may also be made to the first button part 13 as described above. In some embodiments, the first button part 13 includes the NFC assembly.

The operating principle and specific implementation mode of the NFC assembly may refer to the above embodiments, which may not be repeated here.

In order to further improve the user's operating experience when the user triggers the sensing button 211 of the electronic device 20 through the first button part 13, further improvements may be made to the first button part 13. In some embodiments, as shown in FIG. 28, FIG. 28 is a structural schematic view illustrating partial structures of the protective case 10 and the electronic device 20 in an embodiment of the present disclosure. The inner surface of the first button part 13 is flush with or protrudes inward relative to the inner surface of the peripheral area of the opening 101, so that a first protrusion 134 is formed.

The inner surface of the first button part 13 refers to the side of the first button part 13 close to the electronic device 20, and the inner surface of the peripheral area of the opening 101 refers to the side of the peripheral area of the opening 101 close to the electronic device 20. The inner surface of the first button part 13 is flush with the inner surface of the peripheral area of the opening 101, which facilitates the user in assembling the protective case 10 onto the electronic device 20. The inner surface of the first button part 13 protrudes inward relative to the inner surface of the peripheral area of the opening 101, which means that in the assembled state, the inner surface of the first button part 13 protrudes towards a side of the electronic device 20 relative to the inner surface of the peripheral area of the opening 101, forming the first protrusion 134. The design of the first protrusion 134 may reduce the operation process when the user presses the button, improving triggering sensitivity and optimizing the user experience.

In some embodiments, the sensing button 211 of the electronic device 20 is located on the side surface. In the assembled state, the position of the sensing button 211 corresponds to the position of the first button part 13 on the side wall 113 of the protective case 10. When the sensing button 211 of the electronic device 20 is recessed on the side surface of the electronic device 20, the inner surface of the first button part 13 is set to protrude inward, forming the first protrusion 134 that matches the concave shape of the sensing button 211. When the user presses the first button part 13, it may more accurately correspond to the concave position of the sensing button 211, reducing the probability of accidental touch. Moreover, it may also reduce the button-press process and improve operational convenience.

In some embodiments, a protrusion height H1 of the first protrusion 134 ranges from 0.1 mm to 0.5 mm.

When the protrusion height is too high, it may lead to overly strong button feedback, affecting the feel of operation. When the protrusion height is too low, it may not effectively reduce the button-press process. Therefore, choosing a reasonable protrusion height, such as 0.1 mm, 0.2 mm, 0.3 mm, 0.4 mm, or 0.5 mm, may ensure trigger sensitivity and optimize the user experience.

In some embodiments, the protrusion height H1 of the first protrusion 134 ranges from 0.2 mm to 0.3 mm.

The height H1 of the first protrusion 134 is selected within this range, which may further improve the accuracy of operation and provide a better button-press experience for the user.

In some embodiments, as shown in FIG. 29, FIG. 29 is a cross-sectional structural schematic view illustrating partial structure of the protective case 10 after a molding process in an embodiment of the present disclosure. When the protective case 10 is assembled with the electronic device 20, the outer surface of the area of the flexible connection part 12 corresponding to the first button part 13 protrudes outward relative to the outer surfaces of other areas of the flexible connection part 12, forming a second protrusion 135.

The setting of the second protrusion 135 may improve the efficiency and reliability of recognizing the first button part 13, thereby improving the operational efficiency and operational reliability of the electronic device 20.

In some embodiments, it may also be achieved by setting the outer surface of the area of the flexible connection part 12 corresponding to the first button part 13 to be recessed relative to the outer surfaces of other areas of the flexible connection part 12, or by setting the outer surface of the area of the flexible connection part 12 corresponding to the first button part 13 and the case body 11 to have different textures, colors, or reflectivity. In some embodiments, a surface treatment mode such as fluorescence treatment, may be applied to the outer surface of the area of the flexible connection part 12 corresponding to the first button part 13, so that the user may pay attention to the area of the flexible connection part 12 corresponding to the first button part 13 at the first time.

In some embodiments, when the flexible connection part 12 does not cover the first button part 13, the outer surface of the first button part 13 may also be recessed or protruding relative to the outer surface of the peripheral area of the opening 101. Alternatively, it may be achieved by setting the first button part 13 and the case body 11 to have different textures, colors, or reflectivity. In some embodiments, the surface treatment mode such as fluorescence treatment, may be applied to the outer surface of the first button part 13, so that the user may pay attention to the first button part 13 at the first time. In some embodiments, a fluorescent agent is added to the material layer of the first button part 13, so as to help the user better pay attention to the presence of the first button part 13 in a dark environment. In this case, the second protrusion 135 may be omitted, so that the outer surface of the first button part 13 may be disposed flush with the outer surface of the peripheral area of the opening 101.

In some embodiments, a protrusion height H2 of the second protrusion 135 ranges from 0 mm to 0.5 mm. When the protrusion height H2 is 0 mm, it may be understood that the second protrusion 135 is not formed, and the outer surface of the first button part 13 is disposed flush with the outer surface of the peripheral area of the opening 101. In some embodiments, the protrusion height H2 may be 0 mm, 0.05 mm, 0.1 mm, 0.2 mm, 0.3 mm, 0.4 mm, or 0.5 mm.

In some embodiments, the protrusion height H2 of the second protrusion 135 ranges from 0.1 mm to 0.5 mm.

The protrusion height H2 of the second protrusion 135 is selected within the range of 0.1 mm to 0.5 mm, which may ensure the sensitivity of button recognition and avoid the inconvenience during operation caused by excessive protrusion. In some embodiments, the protrusion height H2 may be 0.1 mm, 0.2 mm, 0.3 mm, 0.4 mm, or 0.5 mm, so as to balance the visual effect and the operational feel, further improving the user experience.

In some embodiments, the protrusion height of the outer surface of the overall structure of the flexible connection part 12 and the first button part 13 relative to the outer surface of the case body 11 ranges from 0 mm to 0.5 mm. In some embodiments, this protrusion height may be 0 mm, 0.05 mm, 0.1 mm, 0.2 mm, 0.3 mm, 0.4 mm, or 0.5 mm.

In order to further improve the positional stability between the first button part 13 and the case body 11, in some embodiments, as shown in FIG. 5, the protective case 10 further includes a first positioning film 316, and the first positioning film 316 is disposed on the outer side of the case body 11 and covers at least the opening 101.

The setting of the first positioning film 316 may reduce or prevent the surface material of the case body 11 (such as the first support layer 111, the second support layer 112) from coming into contact with the first button part 13 located in the opening 101 during the molding process of the protective case 10. This contact could otherwise cause the surface of the first button part 13 to become brittle and hard, thereby affecting the function of the button. Therefore, this embodiment may improve the reliability of the first button part 13 and the protective case 10.

In order to further improve the positional stability between the first button part 13 and the case body 11, in some embodiments, as shown in FIG. 5, the protective case 10 further includes a second positioning film 317, and the second positioning film 317 is disposed on the inner side of the case body 11 and covers at least the opening 101.

The setting of the second positioning film 317 may reduce or prevent the surface material of the case body 11 (such as the first support layer 111, the second support layer 112) from coming into contact with the first button part 13 located in the opening 101 during the molding process of the protective case 10. This contact could otherwise cause the surface of the first button part 13 to become brittle and hard, thereby affecting the function of the button. Therefore, this embodiment may improve the reliability of the first button part 13 and the protective case 10.

In some embodiments, the first button part 13 is provided with both the first protrusion 134 and the second protrusion 135, so as to improve the convenience and experience of button-press for the user.

In some embodiments, the thickness of the first support layer 111 and the thickness of the second support layer 112 may be different.

The present disclosure further provides a protective case 10. In some embodiments, as shown in FIG. 30, the protective case 10 includes the case body 11, the flexible connection part 12, and an elastic ring 16. The case body 11 defines the opening 101. The elastic ring 16 is located at the opening 101, and the flexible connection part 12 covers the elastic ring 16 and the opening 101. The elastic ring 16 is integrated with the case body 11 through the flexible connection part 12. The stiffness of the case body 11 is greater than the stiffness of the flexible connection part 12.

There are various ways to achieve the integrated setting. For example, by applying heating or pressure, relevant materials in at least two material layers may be melted, flow to a specific position under the action of pressure or a mold, and then solidify under the influence of temperature or pressure. Alternatively, the material layers may be adhered together using adhesive or the like and then cured to form a connection. The integrated setting mentioned here ensures that at least two material layers form an inseparable whole under non-violent intervention, which is also referred to as a “monolithic structure” or “one-piece structure”.

In some embodiments, the protective case 10 and the electronic device 20 are in the assembled state, and the user may trigger the sensing button 211 of the electronic device 20 corresponding to the opening 101 by pressing the flexible connection part 12 at the opening 101. Furthermore, pressing the flexible connection part 12 at the opening 101 may effectively compress the elastic ring 16, thereby enabling rapid rebound of the flexible connection part 12 at the opening 101 when the user releases the pressure on the flexible connection part 12.

By this setting, the flexible connection part 12 is disposed to cover the elastic ring 16 and the opening 101, so that the protective effect of the protective case 10 on the electronic device 20 may be effectively improved, and the risk of direct exposure of the electronic device 20 at the opening 101 to the external environment may be reduced. Furthermore, the flexible connection part 12 is disposed to cover the elastic ring 16 and the opening 101, which may utilize the flexible connection part 12 to achieve the effect of setting the button on the protective case 10, and reduce the thickness of the protective case 10. Furthermore, the flexible connection part 12 may form a flexible area at the opening 101, and the flexible area is prone to deformation under the external force, reducing the difficulty of disassembling the protective case 10 and improving the sensitivity and reliability of the external operation on the electronic device 20. Furthermore, disposing the elastic ring 16 may improve the rebound effect of the flexible connection part 12 at the opening 101, improving the experience of button-press for the user.

In some embodiments, the improvement of the case body 11 may also refer to the above embodiments, which may not be repeated here.

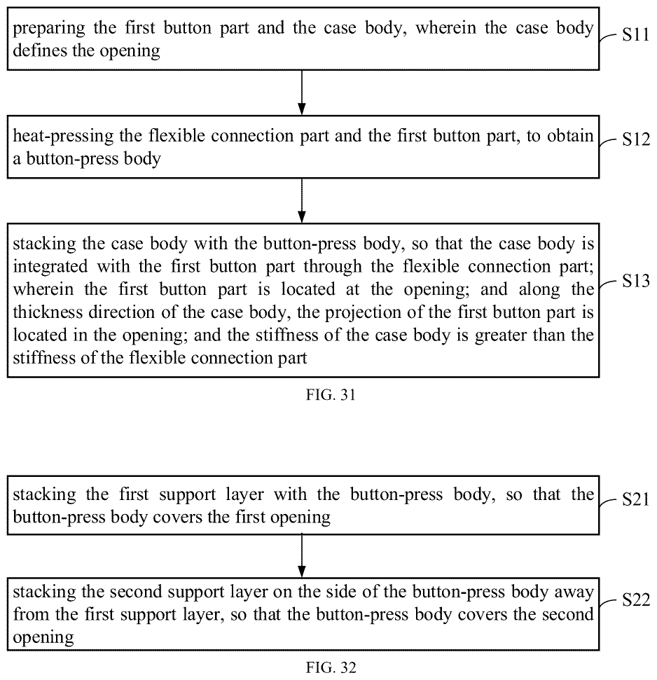

The present disclosure further provides a method for making the protective case 10. In some embodiments, as shown in FIG. 31, FIG. 31 is a flowchart of an embodiment of a method for making the protective case 10 in the present disclosure. The method includes operations at blocks S11 to S13.

At block S11, the method may include preparing the first button part 13 and the case body 11, wherein the case body 11 defines the opening 101.

According to the size and shape of the electronic device 20, a relevant material layer is cut into the case body 11 that matches the size and shape of the electronic device 20. The opening 101 having a corresponding size is defined on the bottom wall 114 or the side wall 113 of the case body 11 according to the application scenario.

Referring to the specific structure of the first button part 13 in the above embodiments, the first button part 13 is prepared by adhering or hot-pressing using corresponding materials.

At block S12, the method may include heat-pressing the flexible connection part 12 and the first button part 13, to obtain a button-press body.

In this way, the flexible connection part 12 is fixedly connected to the first button part 13.

At block S13, the method may include stacking the case body 11 with the button-press body, so that the case body 11 is integrated with the first button part 13 through the flexible connection part 12; wherein the first button part 13 is located at the opening 101; and along the thickness direction z of the case body 11, the projection of the first button part 13 is located in the opening 101; and the stiffness of the case body 11 is greater than the stiffness of the flexible connection part 12.

In some embodiments, the first button part 13 of the button-press body aligns with the opening 101, and at least a part of the flexible connection part 12 is stacked with the peripheral area of the opening 101 on the case body 11. The connection between the flexible connection part 12 and the case body 11 is achieved through the hot-pressing or other processes. This method may simplify the manufacturing process and improve the production efficiency.

In some embodiments, the case body 11 includes the first support layer 111 and the second support layer 112. The first support layer 111 defines the first opening 1011, and the second support layer 112 defines the second opening 1012. As shown in FIG. 32, the operation of stacking the case body 11 with the button-press body in the operation at block S13 includes operations at blocks S21 and S22.

At block S21, the method may include stacking the first support layer 111 with the button-press body, so that the button-press body covers the first opening 1011.

At block S22, the method may include stacking the second support layer 112 on the side of the button-press body away from the first support layer 111, so that the button-press body covers the second opening 1012.

At least a part of the flexible connection part 12 is stacked between the first support layer 111 and the second support layer 112. The stiffness of the first support layer 111 and the stiffness of the second support layer 112 are both greater than the stiffness of the flexible connection part 12.

This setting mode may fix the flexible connection part 12 from both sides through the first support layer 111 and the second support layer 112, improving the stability of the fixing between the flexible connection part 12 and the case body 11, and thus improving the stability of the connection between the case body 11 and the button-press body.

In some embodiments, the operation at block S21 further includes: after stacking the first support layer 111 with the button-press body, so that the button-press body covers the first opening 1011, covering the first positioning film 316 on the outer side of the first support layer 111, so that the first opening 1011 of the first support layer 111 and the button-press body are covered.

In some embodiments, operation at block S22 further includes: after stacking the second support layer 112 on the side of the button-press body away from the first support layer 111, so that the button-press body covers the second opening 1012, covering the second positioning film 317 on the outer side of the second support layer 112, so that the second positioning film 317 covers the second opening 1012 and the button-press body.

The setting of the first positioning film 316 and the second positioning film 317 may reduce or prevent the surface material of the case body 11 (such as the first support layer 111, the second support layer 112) from coming into contact with the first button part 13 located in the opening 101 during the molding process of the protective case 10. This contact could otherwise cause the surface of the first button part 13 to become brittle and hard, thereby affecting the function of the button. Therefore, this embodiment may improve the reliability of the first button part 13 and the protective case 10.

In some embodiments, the case body 11 may be first stacked with the second support layer 112, and then the first support layer 111 is combined, so as to ensure that the button-press body stably covers the opening 101.

In some embodiments, any one or more of the flexible connection part 12, the first flexible layer 301, the second flexible layer 302, the third flexible layer 303, the fourth flexible layer 304, and the fifth flexible layer 305 described in the above embodiments may be a film layer structure that is made of TPU. In some embodiments, the material of each of the flexible layer and the flexible connection part 12 mentioned above may also be silicone, latex, rubber, etc.

The tensile strength of the film layer structure that is made of TPU, as measured according to the ASTM standard, is 38.5 MPa. The ultimate elongation of the film layer structure that is made of TPU, as measured according to the ASTM D412 standard, is 600%. The tensile stress at 100% elongation of the film layer structure that is made of TPU, as measured according to the ASTM D412 standard, is 11.1 MPa. This setting may improve the elasticity and structural stability of the above-mentioned film layer structure, thereby improving the reliability and service life of the protective case 10.

On the inner side of the case body 11, the second positioning film and the flexible layer may be repeatedly disposed, or either one of them may be disposed. On the outer side of the case body 11, the first positioning film and the flexible layer may be repeatedly disposed, or either one of them may be disposed.

### Example Group 2

In some embodiments, the conductive layer 50 may be provided for the embodiments where the conductive layer 50 is not disposed in the embodiments mentioned above. Specific implementation modes may refer to the embodiments with the conductive layer 50 mentioned above.

The protective case 10 with a conductive structure is not limited to the above embodiments.

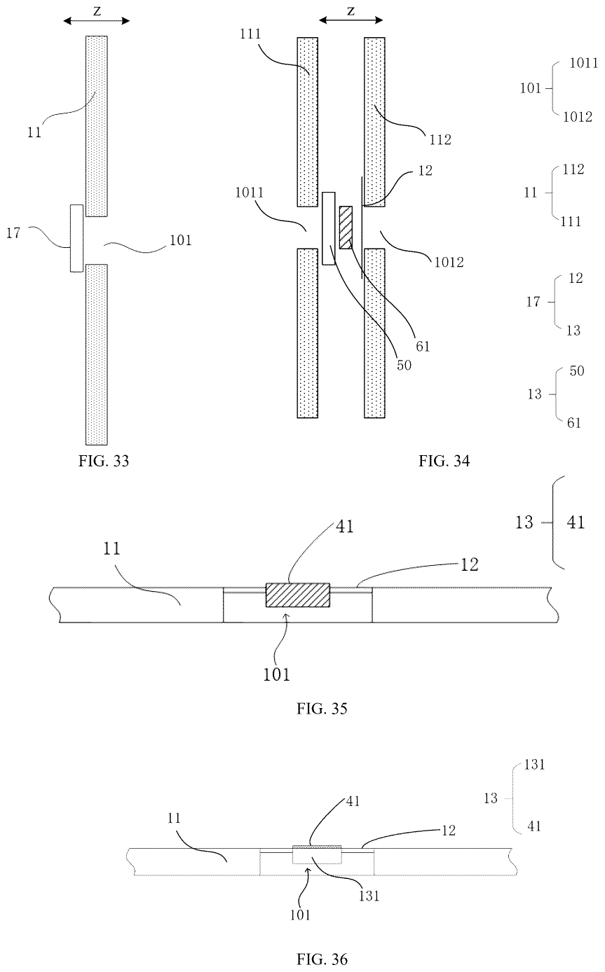

In some embodiments, as shown in FIG. 33, FIG. 33 is a structural schematic view of yet another embodiment of partial structure of the protective case 10 in the present disclosure. The protective case 10 includes the case body 11 and a conductive part 17. The conductive part 17 covers a part area of the case body 11 and is integrated with the case body 11. When the protective case 10 is assembled with the electronic device 20, the conductive part 17 covers the button of the electronic device 20 along the thickness direction z of the case body 11.

As shown in FIG. 1, the case body 11 defines the accommodation chamber 110 that is configured for accommodating at least a part of the electronic device 20. As shown in FIGS. 33 and 34, the conductive part 17 includes the flexible connection part 12 and the first button part 13. The specific implementation modes of the flexible connection part 12 and the first button part 13 may refer to the above embodiments. The button of the electronic device 20 may be the function button 21.

On the one hand, the case body 11 may improve the sensitivity of the part area to the button operation for the electronic device 20 through the conductive part 17. On the other hand, the conductive part 17 is integrated with the case body 11, which may improve the structural stability of the protective case 10 and improve the protection capability for the electronic device 20. In the present disclosure, the sensitivity of the button operation may be improved through the conductive part 17.

In some embodiments, the conductive part 17 covers the inner side of the part area. This structure allows the conductive part 17 to be placed closer to the electronic device 20 in the assembled state of the protective case 10 and the electronic device 20, which may improve the sensitivity of operating the electronic device 20. When the conductive part 17 is located on the outer side of the part area, the conductive part 17 may be subject to interference from the environmental factor other than the finger (such as humidity, stray capacitance). However, disposing the conductive part 17 on the inner side of the part area may reduce such interferences, thereby achieving more stable capacitive coupling.

In some embodiments, the case body 11 defines the opening 101, and the conductive part 17 covers at least the opening 101. When the electronic device 20 is assembled inside the protective case 10, the opening 101 corresponds to the button. In this way, it may reduce the thickness of the protective case 10 corresponding to the button position, and it may also mitigate the impact of the high rigidity of the case body 11 on the button operation, thereby improving the sensitivity of operating the electronic device 20.

In some embodiments, as shown in FIG. 34, FIG. 34 is a structural schematic view of yet another embodiment of partial structure of the protective case 10 in the present disclosure. The case body 11 includes the first support layer 111 and the second support layer 112. The first support layer 111 defines the first opening 1011. The second support layer 112 is stacked with at least a part of the first support layer 111 along the thickness direction z. The second support layer 112 defines the second opening 1012. Along the thickness direction z, the first opening 1011 overlaps at least partially with the second opening 1012 to form the opening 101. At least a part of the conductive part 17 is stacked between the first support layer 111 and the second support layer 112. This setting may improve the structural stability between the conductive part 17 and the case body 11. The structure of the case body 11 may refer to the above embodiments.

In some embodiments, the conductive part 17 includes the conductive layer 50. The specific implementation mode of the conductive layer 50 and the connection structure between the conductive layer 50 and the case body 11 may refer to the above embodiments.

In some embodiments, as shown in FIG. 34, the conductive part 17 further includes the flexible connection part 12. Along the thickness direction z, the flexible connection part 12 is disposed on the outer side of the conductive layer 50. The outer side surface of the conductive layer 50 is covered by the flexible connection part 12. The flexible connection part 12 also covers the peripheral area of the opening 101 and is integrated with the case body 11. The specific analysis and extension of these embodiments may refer to the above embodiments.

In some embodiments, the stiffness of the flexible connection part 12 is less than the stiffness of the case body 11. The specific analysis and extension of these embodiments may refer to the above embodiments.

In some embodiments, as shown in FIG. 34, the conductive part 17 further includes the first body layer 61. Along the thickness direction z of the case body 11, the first body layer 61 is disposed on the outer side of the conductive layer 50, and the outer side surface of the first body layer 61 is covered by the flexible connection part 12. The specific analysis and extension of these embodiments may refer to the above embodiments.

In some embodiments, the conductive layer 50 includes a conductive film. The specific analysis and extension of these embodiments may refer to the conductive film layer 51 of the above embodiment.

In some embodiments, as shown in FIG. 16, the first body layer 61 includes the third flexible layer 303, the fiber layer 42, and the fourth flexible layer 304 stacked in sequence along the thickness direction z. The specific analysis and extension of these embodiments may refer to the above embodiments.

In some embodiments, the electric conductivity of the conductive film layer 51 ranges from 10\hat{ }6 Ω to 10\hat{ }12 Ω. The specific analysis and extension of these embodiments may refer to the above embodiments.

In some embodiments, the specific analysis and extension of the third flexible layer 303, the fourth flexible layer 304, and the fiber layer 42 may refer to the above embodiments.

In some embodiments, as shown in FIG. 17, the flexible connection part 12 is the double-layer structure, including the first flexible layer 301 and the second flexible layer 302. The first body layer 61 includes the third flexible layer 303 and the fiber layer 42. Along the thickness direction z, the first flexible layer 301, the third flexible layer 303, the fiber layer 42, the conductive film layer 51, and the second flexible layer 302 are stacked in sequence. The first flexible layer 301 is disposed on or covers the outer side of the third flexible layer 303, and the second flexible layer 302 is disposed on or covers the inner side of the conductive film layer 51. The specific analysis and extension of these embodiments may refer to the above embodiments.

In some embodiments, as shown in FIG. 17, the first body layer 61 further includes the fourth flexible layer 304 that is stacked between the conductive film layer 51 and the fiber layer 42. The specific analysis and extension of these embodiments may refer to the above embodiments.

In some embodiments, as shown in FIG. 18, the flexible connection part 12 is a single-layer structure, including the first flexible layer 301. Along the thickness direction z, the first flexible layer 301, the third flexible layer 303, the fiber layer 42, the fourth flexible layer 304, and the conductive film layer 51 are stacked in sequence. The first flexible layer 301 is disposed on or covers the outer side of the third flexible layer 303. The conductive film layer 51 is disposed on or covers the inner side of the fourth flexible layer 304, and extends to the peripheral area of the opening 101 on the case body 11. The specific analysis and extension of these embodiments may refer to the above embodiments.

In some embodiments, as shown in FIG. 19, the conductive layer 50 includes multiple conductive areas 521 that are electrically insulated from one another along the first direction x. The first direction x is the length direction of the first button part 13. The specific analysis and extension of these embodiments may refer to the above embodiments.

In some embodiments, as shown in FIG. 19, the conductive layer 50 is a multi-layer structure. The conductive layer 50 includes the first conductive layer 522, the insulation layer 524, and the second conductive layer 523 stacked along the thickness direction z. The first conductive layer 522 is electrically connected to the second conductive layer 523 through the conductive component (not shown) disposed in the via 525 of the insulation layer 524. The specific analysis and extension of these embodiments may refer to the above embodiments.

In some embodiments, the first body layer 61 includes the rigid fiber layer. The specific analysis and extension of these embodiments may refer to the above embodiments.

In some embodiments, as shown in FIG. 20, the flexible connection part 12 is a double-layer structure, including the first flexible layer 301 and the second flexible layer 302. Along the thickness direction z, the first flexible layer 301, the rigid fiber layer, the conductive layer 50, and the second flexible layer 302 are stacked in sequence. The first flexible layer 301 is disposed on or covers the outer side of the rigid fiber layer, and the second flexible layer 302 is disposed on or covers the inner side of the conductive layer 50. The specific analysis and extension of these embodiments may refer to the above embodiments.

In some embodiments, as shown in FIG. 3, the protective case 10 is configured to protect the electronic device 20, and the electronic device 20 is provided with the function button 21. When the electronic device 20 is assembled inside the protective case 10, the conductive part 17 covers at least a part of the function button 21. The specific analysis and extension of these embodiments may refer to the above embodiments.

In some embodiments, the function button 21 includes the sensing button 211. The specific analysis and extension of these embodiments may refer to the above embodiments.

In some embodiments, the electronic device 20 includes the mobile phone, the sensing button 211 includes the shooting button 212, the protective case 10 includes the side wall 113 that is configured for surrounding the side edges of the mobile phone, and the conductive part 17 is disposed on the side wall 113. The specific analysis and extension of these embodiments may refer to the above embodiments.

The relevant structures and extension schemes in this example group may refer to the relevant introduction of the above embodiments.

### Example Group 3

In some embodiments, the conductive layer 50 may be provided for the embodiments where the conductive layer 50 is not disposed in the embodiments mentioned above. Specific implementation modes may refer to the embodiments with the conductive layer 50 mentioned above.

The protective case 10 with the conductive structure is not limited to the above embodiments.

In some embodiments, as shown in FIG. 28, the protective case 10 includes the case body 11 and the first button part 13 connected to the case body 11. The inner surface of the first button part 13 protrudes inward relative to the inner surface of the case body 11, forming the first protrusion 134 on the inner side of the case body 11. When the protective case 10 is assembled with the electronic device 20, the first protrusion 134 covers the button of the electronic device 20 along the thickness direction z of the case body 11.

The button of the electronic device 20 may be the function button 21.

On the one hand, the first protrusion 134 may shorten the distance or create an interference fit between the protective case 10 and the button of the electronic device 20 assembled inside the protective case 10. This may provide timely tactile feedback to the user, thereby improving the sensitivity of the external force applied to the case body 11 to operate the button of the electronic device 20. On the other hand, compared to the solution of exposing the button through the opening 101 on the case body 11 to improve the sensitivity of button operation, in the present disclosure, the distance between the first button part 13 and the button of the electronic device 20 is reduced through the first protrusion 134 inside the case body 11, so as to improve the sensitivity of the button operation. Moreover, the first protrusion 134 covers the button of the electronic device 20, preventing the button of the electronic device 20 from being exposed, and preventing the external substance such as dust, liquid, or the like from entering or infiltrating the button area, thereby improving the protection effect for the electronic device 20. In addition, the wrap-around design of the first button part 13 for the button of the electronic device 20 gives the protective case 10 an integrated aesthetic appeal. When the protective case 10 is assembled with the electronic device 20, the appearance of the protective case 10 is not affected by the appearance of the button of the electronic device 20. In this way, the protective case 10 combines functionality and aesthetics.

In some embodiments, when the protective case 10 is assembled with the electronic device 20, the first protrusion 134 is disposed in an interference fit with the button of the electronic device 20. In this way, when the electronic device 20 is assembled inside the protective case 10, the first button part 13 may be in contact with or abut against the button of the electronic device 20, thereby pre-pressing the button and improving the sensitivity of the external force applied to the case body 11 to operate the button of the electronic device 20.

In some embodiments, the protrusion height of the first protrusion 134 ranges from 0.1 mm to 0.5 mm. The specific analysis and extension of these embodiments may refer to the above embodiments.

In some embodiments, the protrusion height of the first protrusion 134 ranges from 0.2 mm to 0.3 mm. The specific analysis and extension of these embodiments may refer to the above embodiments.

In some embodiments, the first button part 13 is integrated with the case body 11. In this way, the connection strength between the first button part 13 and the case body 11 may be improved, and the external impacts and pressures may be more effectively resisted, thereby improving the structural stability of the protective case 10 and improving the protective effect of the protective case 10 on the electronic device 20.

In some embodiments, the function button 21 of the electronic device 20 is recessed relative to the outer surface of the electronic device 20 where the function button 21 is located. In this way, when the protective case 10 is assembled with the electronic device 20, the first protrusion 134 may fit into the recess, so as to improve the operation accuracy of the first button part 13.

In some embodiments, as shown in FIG. 29, the case body 11 defines the opening 101. The protective case 10 further includes the flexible connection part 12. The first button part 13 is integrated with the case body 11 through the flexible connection part 12 and is located at the opening 101. Along the thickness direction z of the case body, the projection of the first button part 13 towards the opening 101 is located in the opening 101. The stiffness of the case body 11 is greater than the stiffness of the flexible connection part 12. The specific analysis and extension of these embodiments may refer to the above embodiments.

In some embodiments, as shown in FIG. 5, along the thickness direction z of the case body 11, the projection of the flexible connection part 12 covers the projection of the first button part 13 and the opening 101. The specific analysis and extension of these embodiments may refer to the above embodiments.

In some embodiments, as shown in FIGS. 5 to 10, the protective case 10 includes the case body 11 defining the opening 101, the flexible connection part 12, and the first button part 13. The first button part 13 is integrated with the case body 11 through the flexible connection part 12 and is located at the opening 101. Along the thickness direction z of the case body 11, the projection of the first button part 13 is located in the opening 101. As shown in FIG. 11, the gap d is defined between the first button part 13 and the inner wall of the opening 101. The stiffness of the case body 11 is greater than the stiffness of the flexible connection part 12. The specific analysis and extension of these embodiments may refer to the above embodiments.

In some embodiments, as shown in FIG. 29, FIG. 29 is a cross-sectional structural schematic view illustrating partial structure of the protective case 10 after a molding process in an embodiment of the present disclosure. The inner wall 71 of the first button part 13, the inner wall 72 of the opening 101, and the part 73 of the flexible connection part 12 located in the gap form the groove 70. The groove 70 provides the space for the deformation of the flexible connection part 12. The specific analysis and extension of these embodiments may refer to the above embodiments.

In some embodiments, the flexible connection part 12 includes the annular area or the quasi-annular area covering the gap d. The specific analysis and extension of these embodiments may refer to the above embodiments.

In some embodiments, as shown in FIG. 11, the width of the gap d ranges from 0.5 mm to 2 mm. The specific analysis and extension of these embodiments may refer to the above embodiments.

In some embodiments, the width of the gap d is 0.8 mm. The specific analysis and extension of these embodiments may refer to the above embodiments.

In some embodiments, as shown in FIG. 11, the thickness of the flexible connection part 12 at the gap d ranges from 0.1 mm to 0.5 mm. The specific analysis and extension of these embodiments may refer to the above embodiments.

In some embodiments, as shown in FIG. 4, the length h of the first button part 13 ranges from 15 mm to 19 mm, and the width w of the first button part 13 ranges from 1.5 mm to 4 mm. The width of the annular or quasi-annular area, i.e., the width of the flexible connection part 12 at the gap d, ranges from 0.5 mm to 2 mm. The specific analysis and expansion of this embodiment may refer to the above embodiments.

In some embodiments, as shown in FIG. 4, the length h of the first button part 13 is 17.5 mm. The specific analysis and extension of these embodiments may refer to the above embodiments.

In some embodiments, the thickness of the flexible connection part 12 at the gap d is less than the thickness of the first button part 13. The specific analysis and extension of these embodiments may refer to the above embodiments.

In some embodiments, as shown in FIGS. 1 to 3, the protective case 10 is configured to protect an electronic device 20, and the electronic device 20 is provided with the function button 21. When the electronic device 20 is assembled inside the protective case 10, the first button part 13 covers at least a part of the function buttons 21. The specific analysis and extension of these embodiments may refer to the above embodiments.

In some embodiments, the function button 21 includes the sensing button 211. The specific analysis and extension of these embodiments may refer to the above embodiments.

In some embodiments, the electronic device 20 includes the mobile phone, the sensing button 211 includes the shooting button 212, the protective case 10 includes the side wall 113 that is configured for surrounding the side edges of the mobile phone, and the first button part 13 is disposed on the side wall 113. The specific analysis and extension of these embodiments may refer to the above embodiments.

The relevant structures and extension schemes in this example group may refer to the relevant introduction of the above embodiments.

### Example Group 4

In some embodiments, the conductive layer 50 may be provided for the embodiments where the conductive layer 50 is not disposed in the embodiments mentioned above. Specific implementation modes may refer to the embodiments with the conductive layer 50 mentioned above.

The protective case 10 with the conductive structure is not limited to the above embodiments.

In some embodiments, as shown in FIG. 25, the protective case 10 includes the case body 11 defining the opening 101, the flexible connection part 12, and a button part 18. The button part 18 is connected to the case body 11 through the flexible connection part 12 and is located at the opening 101. Along the thickness direction z of the case body 11, the projection of the button part 18 is located in the opening 101. The button part 18 establishes data communication with the electronic device 20 assembled inside the protective case 10 when triggered by the external force. The stiffness of the case body 11 is greater than the stiffness of the flexible connection part 12. On the one hand, the button part 18 located at the opening 101 of the case body 11 is connected to the case body 11 through the flexible connection part 12 with lower stiffness, which may improve the deformation ability of the button part 18 relative to the case body 11, improve the tactile experience of the button part 18, reduce the influence of the case body 11 with higher stiffness on operation of the button part 18, thereby improving the control sensitivity of operating the electronic device 20. On the other hand, disposing the button part 18 at the opening 101 of the case body 11 and connecting the button part 18 to the case body 11 through the flexible connection part 12 may increase the sealing of the opening 101 through the button part 18 and the flexible connection part 12. This may solve the problem of the corresponding button of the electronic device 20 being exposed and not effectively protected. Moreover, the stiffness of the case body 11 is greater than the stiffness of the flexible connection part 12. As the main body of the protective case 10, the case body 11 may effectively protect the entire electronic device 20. In addition, the protective case 10 establishes data communication with the electronic device 20 through the button part 18, which may improve the convenience of operating the electronic device 20.

In some embodiments, the button part 18 includes the first button part 13 and the second button part 14. The first button part 13 is integrated with the case body 11 through the flexible connection part 12, and the second button part 14 is disposed on the inner side of the first button part 13. The first button part 13 triggers the second button part 14 under the external force, so that the second button part 14 may establishes data communication with the electronic device 20 assembled inside the protective case 10. The specific analysis and extension of these embodiments may refer to the above embodiments.

In some embodiments, the button part 18 includes the second button part 14, the second button part 14 establishes data communication with the electronic device 20 assembled inside the protective case 10 when triggered by the external force. The specific analysis and extension of these embodiments may refer to the above embodiments.

In some embodiments, the second button part 14 includes the NFC assembly. The specific analysis and extension of these embodiments may refer to the above embodiments.

In some embodiments, as shown in FIGS. 26 and 27, the NFC assembly includes the electronic trigger 141 and the functional device 142. The electronic trigger 141 is configured to be electrically connected to the functional device 142, and the second button part 14 abuts against the electronic trigger 141 under the external force, thereby triggering the functional device 142. The specific analysis and extension of these embodiments may refer to the above embodiments.

In some embodiments, the electronic trigger 141 includes the circuit board and the switch element, and the functional device 142 includes the FPC coil electrically connected to the circuit board. The specific analysis and extension of these embodiments may refer to the above embodiments.

In some examples, the protective case 10 also has the charging function. In this case, the NFC assembly may be configured to control whether to charge or not.

In some embodiments, the functional device 142 includes the coil. The specific analysis and extension of these embodiments may refer to the above embodiments.

In some embodiments, as shown in FIG. 26, the second button part 14 further includes the pressing part 143 that is disposed on the outer side of the NFC assembly. The pressing part 143 is disposed between the NFC assembly and the first button part 13. The specific analysis and extension of these embodiments may refer to the above embodiments.

In some embodiments, as shown in FIGS. 26 and 27, the inner side wall 113 of the case body 11 defines the limit groove 140 that is communicated to the opening 101, and the electronic trigger 141 is limited to the case body 11 through the limit groove 140. The electronic trigger 141 is configured to engage with the limit groove. The specific analysis and extension of these embodiments may refer to the above embodiments.

In some embodiments, as shown in FIG. 26, the protective case 10 further includes the packaging cover plate 15. The packaging cover plate 15 is connected to the inner side of the electronic trigger 141, that is, the packaging cover plate 15 is connected to the side of the electronic trigger 141 away from the first button part 13. The packaging cover plate 15 is installed on the inner side wall 113 of the case body 11 and covers the limit groove 140. The packaging cover plate 15 is disposed on the side of the protective case 10 close to the electronic device 20. The specific analysis and extension of these embodiments may refer to the above embodiments.

In some embodiments, as shown in FIG. 25, along the thickness direction z of the case body 11, the projection of the flexible connection part 12 covers the projection of the button part 18 and the opening 101. The flexible connection part 12 covers the button part 18 and the opening 101 in the thickness direction z. This facilitates the connection between the flexible connection part 12 and the side wall 113 of the opening 101, and the connection between the flexible connection part 12 and the button part 18, which may improve the stability of the connection between the flexible connection part 12 and the button part 18. Moreover, the covering design of the flexible connection part 12 may effectively reduce the interference of the external factor such as dust on the button part 18, thereby improving the reliability of the button part 18 and improving the protective effect of the protective case 10 on the electronic device 20. The specific analysis and extension of these embodiments may refer to the above embodiments.

In some embodiments, the flexible connection part 12 includes the TPU film, so as to improve the visibility and excellent texture of the flexible connection part 12, and reduce process difficulty, etc. The specific analysis and extension of these embodiments may refer to the above embodiments.

In some embodiments, as shown in FIG. 37, the first button part 13 includes the third flexible layer 303, the fiber layer 42, and the fourth flexible layer 304. The flexible connection part 12 is a double-layer structure, including the first flexible layer 301 and the second flexible layer 302. Along the thickness direction z of the case body 11, the first flexible layer 301, the third flexible layer 303, the fiber layer 42, the fourth flexible layer 304, and the second flexible layer 302 are stacked in sequence. The specific analysis and extension of these embodiments may refer to the above embodiments.

In some embodiments, the third flexible layer 303 and the fourth flexible layer 304 both include the TPU film, and the fiber layer 42 includes the aramid fibers. The specific analysis and extension of these embodiments may refer to the above embodiments.

The relevant structures and extension schemes in this example group may refer to the relevant introduction of the above embodiments.

The method for making the protective case 10 in the present disclosure is configured to prepare the protective case 10 in the above embodiments. The method may be adjusted based on the different structures of the protective case 10, and all these adjustments are included in the protection scope of the present disclosure.

Different from the related art, the effects of the present disclosure are as follows. The protective case in the present disclosure includes a case body defining an opening, a flexible connection part, and a first button part. The first button part is integrated with the case body through the flexible connection part and is located at the opening. Along a thickness direction of the case body, a projection of the first button part is located in the opening. In this way, on the one hand, the first button part located at the opening of the case body is connected to the case body through the flexible connecting part, which may improve the mobility of the first button part relative to the case body. This creates a localized flexible area on the case body, which may improve the operation feel of the first button part and improve the precision of operating the electronic device. On the other hand, the first button part is disposed at the opening of the case body, and the first button part is connected to the case body through the flexible connecting part. The sealing of the opening may be improved through the first button part and the flexible connecting part. This may solve the problem of the button of the electronic device being exposed and not effectively protected. Moreover, the case body is integrated with the flexible connecting part and the first button part, which may improve structural stability of the protective case, thereby further improving protective capability for the electronic device.

The above descriptions are only some embodiments of the present disclosure, and are not intended to limit the protection scope of the present disclosure. Any equivalent structure or equivalent flow transformation made by using the contents and the accompanying drawings of the present disclosure, or directly or indirectly applied to other related technical fields, is included in the protection scope of the present disclosure.

1. A protective case, comprising:
a case body, defining an opening;
a flexible connection part; and
a first button part, wherein the first button part is integrated with the case body through the flexible connection part and is located at the opening; along a thickness direction of the case body, a projection of the first button part is located in the opening; and the first button part, the flexible connection part, and the case body form a one-piece structure that is inseparable,
wherein the case body further includes a first support layer defining a first opening, and a second support layer stacked with at least a part of the first support layer along the thickness direction, wherein the second support layer defines a second opening, and along the thickness direction, the first opening overlaps at least partially with the second opening to form the opening, wherein at least a part of the flexible connection part is stacked between the first support layer and the second support layer.

2. The protective case according to claim 1, wherein a stiffness of the case body is greater than a stiffness of the flexible connection part.

3. The protective case according to claim 2, wherein elasticity of the flexible connection part is greater than elasticity of the case body.

4. The protective case according to claim 3, wherein along the thickness direction, a projection of the flexible connection part covers the opening and the projection of the first button part.

5. (canceled)

6. The protective case according to claim 1, wherein a stiffness of the first support layer and a stiffness of the second support layer are both greater than a stiffness of the flexible connection part.

7-14. (canceled)

15. The protective case according to claim 1, wherein an inner surface of the first button part is flush with or protrudes inward relative to an inner surface of a peripheral area of the opening, so that a first protrusion is formed.

16. The protective case according to claim 3, wherein a gap is defined between the first button part and an inner wall of the opening.

17. The protective case according to claim 16, wherein an inner wall of the first button part, the inner wall of the opening, and a part of the flexible connection part located in the gap form a groove; and the groove provides a space for deformation of the flexible connection part.

18. The protective case according to claim 17, wherein the flexible connection part comprises an annular area or a quasi-annular area covering the gap.

19. A protective case, comprising:
a case body, defining an opening, wherein the case body comprises an aramid fiber layer made of an aramid fiber material;
a flexible connection part; and
a first button part, integrated with the case body through the flexible connection part and is located at the opening, wherein the first button part, the flexible connection part, and the case body form a one-piece structure that is inseparable,
wherein the case body further includes a first support layer defining a first opening, and a second support layer stacked with at least a part of the first support layer along a thickness direction of the case body, wherein the second support layer defines a second opening, and along the thickness direction, the first opening overlaps at least partially with the second opening to form the opening, wherein at least a part of the flexible connection part is stacked between the first support layer and the second support layer.

20. The protective case according to claim 19, wherein the first button part comprises the aramid fiber layer and a conductive layer that are stacked on each other, and the conductive layer is located on an inner side of the aramid fiber layer.

21. The protective case according to claim 1, wherein the opening is a through hole, and entire first button part is located in the through hole.

22. The protective case according to claim 1, wherein entire first button part is completely located on a surface of the flexible connection part.

23. The protective case according to claim 1, wherein the flexible connection part is only connected to two opposite ends of the first button part.

24. A protective case, comprising:
a case body, defining an opening;
a flexible connection part; and
a first button part, wherein the first button part is integrated with the case body through the flexible connection part and is located at the opening; along a thickness direction of the case body, a projection of the first button part is located in the opening;
wherein the case body further includes a first support layer defining a first opening, and a second support layer stacked with at least a part of the first support layer along the thickness direction, wherein the second support layer defines a second opening, and along the thickness direction, the first opening overlaps at least partially with the second opening to form the opening, wherein at least a part of the flexible connection part is bonded to the first support layer and/or the second support layer.

25. The protective case according to claim 24, wherein a stiffness of the case body is greater than a stiffness of the flexible connection part.

26. The protective case according to claim 25, wherein elasticity of the flexible connection part is greater than elasticity of the case body.

27. The protective case according to claim 26, wherein along the thickness direction, a projection of the flexible connection part covers the opening and the projection of the first button part.

28. The protective case according to claim 24, wherein a stiffness of the first support layer and a stiffness of the second support layer are both greater than a stiffness of the flexible connection part.

29. A protective case, comprising:
a case body, defining an opening;
a flexible connection part; and
a first button part, wherein the first button part is integrated with the case body through the flexible connection part and is located at the opening; along a thickness direction of the case body, a projection of the first button part is located in the opening; wherein the case body and/or the first button part includes a fiber layer.
